(19) United States
(12) Patent Application Publication
(10) Pub. No.: US 2009/0089217 A1
(43) Pub. Date: Apr. 2, 2009

(54) Method and Apparatus for Issue and Trade of Real Estate Options

(76) Inventor: Vladislav V. Kroutik, San Diego, CA (US)

Correspondence Address: PHILIP H. BURRUS, IV, 460 Grant Street, Atlanta, GA, 30312, US

(21) Appl. No.: 12/058,930

(22) Filed: Mar. 31, 2008

Related U.S. Application Data
(63) Continuation-in-part of application No. 11/865,899, filed on Oct. 2, 2007.
(60) Provisional application No. 61/035,588, filed on Mar. 11, 2008.

(51) Int. Cl. G06Q 30/00; G06Q 40/00; G06Q 20/00; G06Q 10/00

(52) U.S. Cl. 705/80; 705/37; 705/400

(57) ABSTRACT

An electronic system—and associated method—for creating, marketing, and selling real estate options, represented by an option contracts for individual real estate parcels is provided. A system and method for providing a liquid market for real estate options is also provided. The system includes, a central controller, coupled to a network, having a trading system that processes the purchase and sale real estate parcel based options, an investor interface with which investors communicate with the central controller, and a real estate owner interface with which real estate owners communicate with the server. A real estate owner creates, through the system a real estate option offering, which is presented to a plurality of investors. Each investor may purchase the option with a purchase commitment. The investors may later trade the real estate parcel option via the system.

### CROSS REFERENCE TO PRIOR APPLICATIONS

This application claims priority and benefit under 35 U.S.C. § 119(e) from U.S. Provisional Application No. 61/035,588, filed Mar. 11, 2008, which is incorporated herein by reference. This application is a continuation-in-part of U.S. application Ser. No. 11/865,899, filed Oct. 2, 2007, which is incorporated by reference for all purposes.

### BACKGROUND

1. Technical Field

This invention relates generally to a method and an apparatus for creating financial derivative on an individual real estate parcel with real estate option sold to one or more investors using electronic networks and automated trading systems.

2. Background Art

Real estate investments are the largest asset class in the United States. However, investments in real estate are not very liquid, as compared to stocks and bonds. For example, homeowners who hold a large percentage of their wealth in real estate, mostly in their homes, are not diversified and are sensitive to price declines of their homes.

Remarkably, while the debt and equity markets are highly liquid, the real estate market is not. An increased liquidity in the real estate market would make the overall market more efficient, which would generate more wealth.

For example, a house is the primary investment asset for most families and comprises 48% of a homeowner's net worth. The challenge for some property owners is to unlock the value of this asset without having to sell their home prematurely, or take out an expensive home equity loan. In addition, property owners are sensitive to price declines of their homes and stand to lose a large portion of their wealth when price declines occur.

On the other hand, investors are limited in ways they can invest in private real estate. For example, investors who invest into mortgage backed securities offer a fixed return and do not benefit from real estate price volatility and price changes. Furthermore, the recent turmoil in mortgage backed securities left investors with limited choices. Investors are exposed to idiosyncratic risk which can be diversified with investment in real estate.

There is thus a need for an improved method and system for financial liquidity in the real estate.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a schematic block diagram illustrating a real estate option sale management system in accordance with the invention.

FIG. 2 illustrates one embodiment of a block diagram showing a central controller in accordance with the invention.

FIG. 3 illustrates one embodiment of a block diagram showing a real estate owner interface in accordance with the invention.

FIG. 4 illustrates one embodiment of a block diagram showing an investor interface in accordance with the invention.

FIG. 5 illustrates one embodiment of a method for generating a real estate option offer in accordance with the invention.

FIG. 6 illustrates one embodiment of a method for an acceptance of a real estate option offer by a central controller in accordance with the invention.

FIG. 7 illustrates one embodiment of a method for an activation of a real estate option offer in accordance with the invention.

FIG. 8 illustrates one embodiment of a method for maintenance of active real estate option offers in accordance with the invention.

FIG. 9 illustrates one embodiment of a method for selecting a real estate option offer by an investor in accordance with the invention.

FIG. 10 illustrates one embodiment of a method for binding of an investor commitment offer in response to a real estate option offer in accordance with the invention.

FIG. 11 illustrates one embodiment of a method for binding of an investor commitment offer in response to a real estate option offer in accordance with the invention.

FIG. 12 illustrates one embodiment of a method for completing a real estate option offer and a payment between an investor and a real estate owner in accordance with the invention.

FIG. 13 illustrates one embodiment of a method for implementing a payment in accordance with the invention.

FIG. 14 illustrates one embodiment of a method for implementing counteroffers by an investor in accordance with the invention.

FIG. 15 illustrates one embodiment of a method for implementing counteroffers by an investor in accordance with the invention.

FIG. 16 illustrates one embodiment of a method for generating an investor sale offer or an investor purchase offer and subsequently being accepted by a central controller in accordance with the invention.

FIG. 17 illustrates one embodiment of a method for accepting and maintaining active investor sale offers and investor purchase offers in accordance with the invention.

FIG. 18 illustrates one embodiment of a method for accepting and maintaining active investor sale offers and investor purchase offers in accordance with the invention.

FIG. 19 illustrates one embodiment of a method for accepting and maintaining active investor sale offers and investor purchase offers in accordance with the invention.

FIG. 20 illustrates one embodiment of a method for completing a transaction between investors of investor purchase offer and investor sale offer in accordance with the invention.

FIG. 21 illustrates one embodiment of a method for maintaining real estate option offers which pay dividends in accordance with the invention.

FIG. 22 illustrates one embodiment of a schematic block diagram illustrating a method of real estate option sale management system in accordance with the invention.

FIG. 23 illustrates one embodiment for method for creating, marketing, and selling real estate call options in accordance with the invention.

FIG. 24 illustrates one embodiment for method for creating, marketing, and selling real estate put options in accordance with the invention.

FIG. 25 illustrates one embodiment of a method for determining and distributing real estate option payoff at the contract expiration.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to securitizing and financing real estate with real estate option sold to one or more investors. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

Embodiments of this invention relate generally to a method and apparatus for facilitating an original issue of financial derivatives called options contracts in an underlying individual parcel of real estate. Real estate is a large asset class and although most assets on the market today are traded with financial options, real estate assets are not. We developed a method and a system by which one can apply financially sound option contracts to individual real estate properties. These real estate option contracts are not equity sharing agreements, nor do they imply any partial real estate ownership. Instead, a real estate parcel option product is based on observed changes in real estate prices.

The individual parcel of real estate is not a pool or combined holding of a Real Estate Investment Trust (REIT), but is rather a single parcel of real estate such as a private residence or commercial site. Embodiments of the invention also facilitate sale of the real estate option to public investors across an automated exchange. This system includes facilitation of an active, on-going, multilateral market between investors. Embodiments of the invention allow parcel owners to receive money from a plurality of investors for the purchase of an option contract corresponding to an individual parcel of real estate.

Embodiments of the invention also allow real estate owners to extract money from a parcel that is already owned by issuing real estate options in that property in the form of call options. Alternatively, real estate owners can insure against a parcel's decline in value via put options. Further, investors are able to actively trade the issued options with other investors on the exchange. One advantage of one embodiment of the invention is that real estate parcel owners are able to receive money without mortgaging their property. Another advantage of one embodiment of the invention is that parcel owners are able to insure real estate parcel price decline.

In one embodiment, communications between real estate owners and investors are conducted using an electronic network and central controller. The term “real estate owner” will be used herein to refer to either owners of real estate parcels looking to extract money by selling call options in an already owned real estate parcel or owners of real estate parcels looking to insure price decline of an already owned real estate parcel by purchasing put options. A “parcel” is used herein to refer to a single piece of real estate, e.g. a residential home or a singular business property.

A real estate owner who wishes to sell a real estate call option or to purchase a real estate put option in an individual real estate parcel accesses the central controller, which may be located at a remote server across a network. The real estate owner then creates a Real Estate Option Offer (REOO) to get debt free cash by selling a call option, or to obtain price decline protection with a put option. In one embodiment, the real estate option is only for a percentage of the payoff at the expiration of the contract. The payoff maybe realized when the option is expired or exercised. In the initial option offer, the owner and investor may negotiate contract expiration date, expected future parcel value, and other conditions as required by the investor.

By way of example, let us take a homeowner who lives in La Jolla, Calif. The price of his or her home is $1,000,000. In one embodiment, this price can be derived from a combination of the last sale price of the property scaled by a weighted average of price adjustments based upon property index price data changes. Further, the homeowner believes that the price of the home in five years will not be above $1,200,000, and is willing to sell an interest in any upside derived value above that price. Note that the parcel does not have to be sold for the derived price to exceed $1,200,000. The price can be derived without an actual sale of the property. On the other side of a transaction as set forth in accordance with embodiments of the invention set forth herein, an investor may believe that the price of the property will be above $1,200,000 in five years. Such an investor may want to profit from the price appreciation above $1,200,000 and is willing to purchase a “call option.” In exchange, the homeowner will receive debt-free cash today.

To create REOO call contract based on this example, the homeowner creates the offer to sell a “call option” for a term of 5 years and with an expected future price of $1,200,000. In one embodiment, the price of such an option is based upon given the data about price volatility and risk-free investment return rate using binominal trees or Blacks-Sholes methodology. For the purposes of this discussion, the homeowner should get $60,321 today for such an option.

In five years, the investor payoff is based on an observed price of the property as determined by one embodiment of the invention described later. If the observed price were above $1,200,000, the investor would receive the difference. In this example, if the price is $1,400,000, the investor receives $200,000. On the other hand, if the observed price is below $1,200,000, the investor gets nothing.

Once the REOO has been created, the real estate owner then attaches user identification to the REOO. The REOO is then transmitted to the central controller across the network. Examples of transmission schemes of the present invention include a world-wide-web interface, such as a web browser or portal, electronic mail, voice mail, facsimile, or postal mail. The system may attach standard legal provisions and boilerplate language to the REOO, and may further “fill in the gaps” to complete the REOO.

By way of another example, presume a homeowner who lives in La Jolla, Calif. has a home worth $1,000,000. As noted above, this price can be derived from a combination of the last sale price of the property scaled by a weighted average of price adjustments based upon property index price data changes. Further, this homeowner believes that the price of the home in five years will decline below $800,000 and wants to insure against downside risk. An investor believes that price of that specific property will not go below $800,000 in five years and is willing to insure against price declines below this price. When the homeowner purchases the option, the investor receives money today.

To create REOO put contract based on this example, the homeowner creates an offer to buy a “put contract” for a specific term of five years, with an expected future price of $800,000. In one embodiment, such an option is priced according to given the data about price volatility and risk-free investment return rate using binominal trees or Blacks-Sholes methodology. For this example, presume such modeling process this option at $3,062.

In five years, the homeowner's payoff is based on the observed price of the property, which is determined by one embodiment of the invention described later. If the observed price is below $800,000, the homeowner gets the difference between the option price and the actual value. In our example, if the price were $600,000, the homeowner would receive $200,000. On the other hand, if the observed price is above $800,000, the homeowner gets nothing.

Before transmitting the REOO to potential investors, the central controller first authenticates the real estate owner's unique identification number. In one embodiment, this authentication is made possible by a real estate owner database, which includes publicly available information about the real estate parcel. The central controller may require additional verification by requesting that the real estate owner provide a social security number or other personal information. This personal information may be used for credit verification, existing debt obligation verification, income sources and expense verification. The personal information may also be used to ensure that the real estate owner has sufficient debt-free equity available to cover the payoff that might be required by the REOO.

Once the verification process is complete, the central controller then assigns a unique tracking number to the REOO. The REOO is then presented globally so that it becomes available for viewing by potential investors. The REOO may be categorized with other REOOs, perhaps by property location, to make it easier for potential investors to identify relevant REOOs. Thus, an investor interested in REOOs in the state of Florida could log onto a web portal and peruse a listing of Floridian REOOs. In one embodiment, the investor may have to be pre-qualified to access REOO listings.

If, after reviewing a particular REOO, a potential investor wishes to participate in the REOO, the investor communicates his interest to the central controller. The central controller then timestamps the interest message and authenticates the identity of the investor, as well as his capacity to deliver the funds set forth in the REOO. The central controller then verifies that the REOO is “active” and available for participation. If a REOO is available for participation by only one investor, it is “completed” when the first qualified investor accepts it. Subsequent investors will not be able to participate in a “completed” REOO, but may be added to a corresponding waiting list.

If a REOO is available for participation to many investors, subsequent investors will be able to participate in the same REOO until the funding set forth in the REOO is obtained. Once this funding is obtained, the REOO is marked “completed” and additional investors may be added to a waiting list. When an investor participates in an active REOO, the central controller assigns a unique tracking number to the investor's participation. The participation details are then stored in a database. Once participation is confirmed, the real estate owner and investor become parties to a legally binding contract.

In another embodiment, the central controller manages payments between the real estate owner and investor automatically. Various methods of payment may be used in accordance with the invention, including payment by credit cards, personal checks, electronic funds transfer, debit cards, and digital cash. The payment system may also involve the use of an escrow account associated with the REOO wherein a trustee maintains funds advanced by the parties until the REOO is complete. Moreover, payment timing may be varied, depending upon application. For instance, the real estate owner may receive funds immediately after the investor commits funds. Alternatively, payment may be delayed until after the real estate owner performs and signs all required documents and they are recorded.

In another embodiment of the invention, an investor may be given an option of responding to a REOO by issuing a counteroffer with conditions different from the original. In such a scenario, the investor transmits the counteroffer to the central controller. The central controller, in turn, forwards the counteroffer to the real estate owner. Upon receiving the counter offer, the real estate owner is given the option of accepting the counteroffer. Where the counter offer is accepted, the investor becomes bound to the investor for the terms of the counter offer.

In one embodiment, the REOO may be constructed to pay dividends. The dividends may be used to enhance the attractiveness of a REOO. Where dividends are used, the central controller maintains dividends obligations and facilitates transactions required for payment. The central controller may also record dividend payments on the exchange.

While one embodiment of the present invention is intended for networked use, embodiments of the present invention may also take off-line forms. Instead of using electronic mail or web-based servers, for example, real estate owners and investors may communicate with the central controller via telephone, facsimile, postal mail, or another off-line communication tool. For instance, real estate owners may use telephones to create REOOs (with or without the assistance of live agents). Similarly, potential investors may use a telephone to browse and bind REOOs.

Once REOO is completed, an investor may use the system to sell the real estate option interest obtained to other investors. The investor does this by communicating an offer to sell the real estate option to the central controller and specifying selling price and time of offer expiration. Other investors may have an interest in purchasing existing real estate option traded on an exchange. Such investors may communicate their offer to purchase to the central controller, specifying purchase price and time of offer expiration. The central controller monitors orders received from buyers and sellers. Where a match is found, the controller executes transaction and real estate option ownership rights are transferred from seller to buyer. The controller instructs a settlement system to transfer funds between parties. During such a transaction, the real estate owner who originally sold real estate options is unaffected.

In one embodiment, security protocols are used. For example, cryptographic protocols may be used to authenticate the identity of buyers and/or sellers, as well as to verify the integrity of buyer and seller communications with the central controller. Using cryptography or other technologies such as biometrics, the central controller can make it significantly more difficult for unauthorized persons to tamper with the system.

Similarly, the system in one embodiment works to maintain buyer and seller anonymity. For numerous privacy and competitive reasons, buyers and sellers often prefer not to have their identities revealed to the general public when engaging in commercial transactions. Embodiments of the invention offer such protection through the use of identification numbers stored in a database secured by the central controller.

One embodiment of a central controller suitable for use with the invention includes three controller components, which embody six systems: a membership system, a pricing system, a REOO system, a trading system, a clearing system and a compliance system. The membership system authenticates the identity of real estate owners and investors. The pricing system prices new REOOs or existing real estate option. The REOO system facilitated creation of the REOO and also posts the REOO to investors. The trading system records and facilitates real estate option trades. The clearing system settles money between all parties once transactions are completed. The compliance system stores a log of all activities in the central controller and performs system and compliance audits. This multi-system configuration allows for ease of controller distribution among specialized servers.

Where disputes arise, one embodiment of the invention offers a mechanism for dispute resolution. In one embodiment, the system attaches binding arbitration clauses to REOOs. The central controller may serve as an arbitrator or may refer the dispute to a third-party arbitrator for resolution.

Embodiments of the invention provide advantages not found in the prior art. First, the system provides the ability for real estate owners to access to money from plural investors by selling real estate options call in a single real estate parcel. Second, the system provides the ability for real estate owners to insure price decline through plural investors by purchasing real estate options put in a single real estate parcel. Next, the system allows real estate owners to reach a large number of remotely located investors—investors who normally would not be able to afford to find the real estate parcel associated with the REOO. Forth, the system allows investors to obtain leverage by participating in the appreciation of a real estate parcel that is worth substantially more than their investment by providing the real estate owner with a fraction of funds set forth in the REOO. Next, the system allows real estate owners to issue real estate option and globally communicate the option offer to investors. Transaction costs are minimal, and the system provides liquidity for the real estate option sold with a REOO.

The real estate owner offering option remains the owner of the parcel. The system maintains a conformance record of all covenants required by the REOO. When the parcel is sold or the option expires, the system determines the option payoff according to original REOO and distributes the appropriate funds to the property owner and investors on record.

Thus, embodiments of the invention provide a vehicle for permitting investors to benefit from appreciation in real estate price changes and diversification with investment in mixed-asset portfolio. It is a goal of embodiments of the present invention to provide a robust system that matches real estate owners having a desire to raise money or purchase the insurance with investors capable of providing financing or capable of providing insurance. The power of a central controller to field real estate option offers from real estate owners and investors, communicate those offers globally in a format which can be efficiently accessed and analyzed by other investors, effectuate performance of resulting sale of real estate option, trade between parties, resolve disputes arising from those transaction, and maintain billing, collection, authentication, and anonymity makes the present invention an improvement over conventional systems.

As will be illustrated and described herein, an electronic system for creating, marketing, and selling real estate options, represented by option contract for individual real estate parcels, between an owner of the individual real estate parcel and at least one of a plurality of investors is provided. The system includes a central controller having a network interface coupled to a network. The central controller includes and facilitates a trading system configured to process purchase and sale of one of the real estate parcel based option offerings. The central controller also includes an investor interface coupled to the network interface across the network. The investor interface is configured to receive investor input. A real estate owner interface, which is a part of the central controller and is coupled to the network interface across the network, is configured to receive real estate owner input.

The central controller further comprises a pricing system that is configured process investor requests received by the electronic system for real estate parcel based option offering prices. The pricing system is further configured to deliver one or more real estate parcel based option offerings in response to the investor requests. The pricing system also is configured to process offering requests received by the electronic system for option offerings, and to deliver one or more option offering options in response to the offering requests.

A clearing system, also a part of the central controller, is configured to process financial transactions associated with the purchase and sale of the real estate parcel based option offerings. A compliance system maintains records of central controller transactions. A real estate option offering system configured to process requests by real estate owners to initiate real estate parcel based option offerings.

A real estate information system communication coupling, which may be connected to the central controller across the network between the central controller and a real estate information system, is configured to receive information validating real estate parcel value, existing debt, property conditions and historical price index change for the area. A bank communication coupling, connected across the network between the central controller and a bank, is configured to receive information validating funds from the bank. A credit agency communication coupling, connected across the network between the central controller and a credit agency, is configured to receive information validating real estate owner personal information from the credit agency.

A membership system, which is included in one embodiment of the central controller, works with a real estate owner database and an investor database to authenticate an identity of at least one real estate owner and at least one investor by matching identities of real estate owners stored in the real estate owner database with certain system users. The membership system may also match identities of investors stored in the investor database with other certain system users.

A real estate option offering database, which is accessible by the central controller, is configured to invoke the real estate option offering system to create a plurality of option shares corresponding to the real estate parcel information, and to store them in a real estate option offering database. In one embodiment, the real estate option offering database comprises a plurality of databases, accessible by the central controller. The plurality of databases can include at least a purchase commitment database for storing purchase commitments of the real estate parcel based option offerings, and a clearing database for storing transaction data relating to the real estate parcel based option offerings. Other databases may be included as well, each database being accessible by the central controller, including at least a purchase commitment database for storing purchase commitments of the real estate parcel based option offerings, and a clearing database for storing transaction data relating to the real estate parcel based option offerings. Additional databases include a contract detail database, a real estate options database, and a payment database an audit database, an escrow database, and an investor offers database.

The central controller, upon receiving a request from the investor interface, is configured to invoke the pricing system to retrieve one or more option shares from the real estate option offering database, associate a price with the one or more option shares, and to deliver the price to the investor interface. Upon receiving a purchase commitment from the investor interface, the central controller is configured to invoke the trading system to generate an identifier specifying at least a financial account. The identifier is associated with the purchase commitment, which is stored with the identifier in the purchase commitment database. Once the purchase commitment is stored in the purchase commitment database, the central controller is configured to invoke the clearing system to transfer funds from an investor account to a real estate owner account.

A method for creating, marketing, and selling real estate options, represented by options contract for individual real estate parcels, between an owner of the individual real estate parcel and at least one of a plurality of investors, is also described. The steps of the method include providing a networked, electronic, exchange apparatus having a central controller, as described above, and receiving electronic real estate parcel data from the owner interface, where the electronic real estate parcel data comprising at least an address last recorded sale date and last recorded sale price. Once the electronic real estate parcel data is received, the central controller performs the step of generating a real estate parcel based option offer associated with the electronic real estate parcel data and delivers the real estate parcel based option offer to the investor interface. In one embodiment, the real estate parcel based option offering comprises at least an expected future parcel value, a contract expiration date, and purchase price.

The investors then get involved and transmit, through the investor interface, purchase commitments. Thus, the central controller performs the step of receiving at least one purchase commitment from the investor interface in response to the step of delivering the real estate parcel based option offer. The central controller also receives an electronic financial account identifier associated with the at least one purchase commitment from the investor interface and executes an electronic transfer of funds via the electronic financial account identifier. Once the purchase commitment is received, the central controller executes the step of determining whether the purchase commitment meets or exceeds the minimum purchase price. The central controller also executes the steps of validating the electronic real estate parcel data and validating the at least one purchase commitment. The central controller is further responsible for delivering the at least one purchase commitment to the owner interface upon receiving the at least one purchase commitment, receiving additional transaction details from the owner interface; and generating, electronically, a counteroffer and delivering the counteroffer to the investor interface. All transactions may be tracked throughout the process. For instance, the central controller may perform the steps of adding a tracking number and time stamp to one of the real estate parcel based option offering or the at least one purchase commitment.

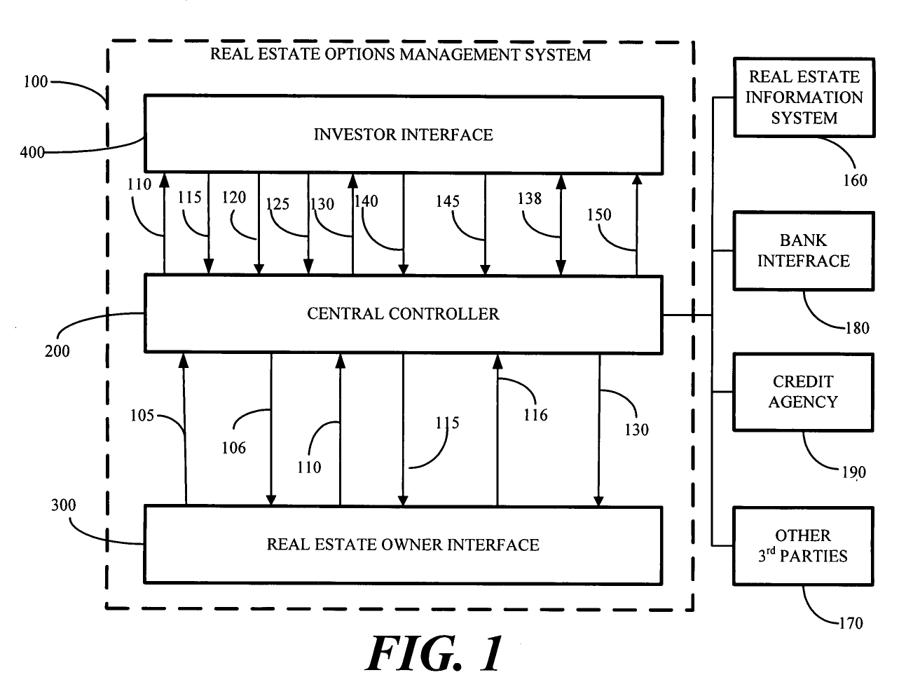

Turning first to FIG. 1, illustrated therein is one embodiment of an electronic system 100 for creating, marketing, and selling real estate options, represented by options contract for individual real estate parcels, between an owner of the individual real estate parcel and at least one of a plurality of investors. The system 100 will be referred to herein as a “Real Estate Options Exchange” (ROE) system for discussion purposes. In one embodiment, the ROE includes a central controller 200, a real estate owner interface 300, and an investor interface 400.

The system 100 receives real estate details 105 from real estate owner and provides the real estate owner with plurality of a real estate options offers for sale 106. The system 100 further receives selected REOOs 110 from real estate owners, and then makes them available for viewing by potential investors. The system 100 allows investors to purchase REOOs as one entire interest or partial interest real estate option. Thus, a real estate owner is able to communicate his initial offer to share a price appreciation above the predetermined future price at the specific date and commitment associated with an individual real estate parcel to an investor. Such an offer provides the investor with the confidence that if he purchases options, he will benefit from the corresponding financial rewards. Once REOO 110 has been purchased by investors, the system 100 allows investors to buy or sell real estate options in an active, liquid market. The options may be owned by investors and offered in an investor sale offer 140, or may be solicited by other investors with investor purchase offer 145.

FIGS. 1 through 4 illustrate one preferred architecture for a system 100 in accordance with the invention. As shown in FIG. 1, the system 100 includes a central controller 200, a real estate owner interface 300, an investor interface 400, a real estate information system 160, a bank interface 180, a credit agency 190, and a connection to various other third parties 170. Each of these connections is referred to as a “node.”

Each node is connected to another via a network connection, such as an Internet connection. The connection may be accomplished using a public switched telephone or broadband network, such as those provided by a local or regional telephone operating company. Communication connections may also be provided by dedicated data lines, cellular, Personal Communication Systems (“PCS”), microwave, or satellite networks. The nodes serve as the input and output gateways for communications with central controller 200.

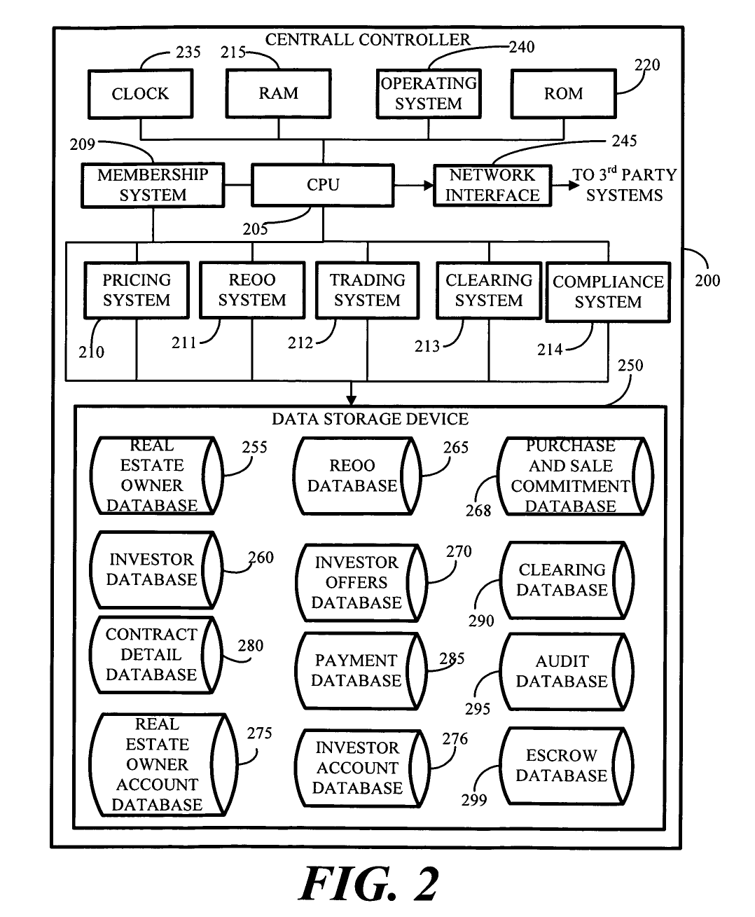

Turning now to FIG. 2, the central controller 200 includes central processor (CPU) 205, RAM 215, ROM 220, the membership system 209, the pricing system 210, the REOO system 211, the trading system 212, the clearing system 213, the compliance system 214, and other components, such as a clock 235, an operating system 240, a network interface 245, and a data storage device 250. Each of the systems may comprise executable software, functional with the CPU, and stored in memory. A conventional server computer with sufficient memory and processing capability may be used as central controller 200. In one embodiment the central controller 200 operates as a web server, both receiving and transmitting REOOs 110 generated by real estate owners. The central controller 200 may also receive and transmit ISOs 140 and IPOs 145.

In one embodiment, the central controller 200 is configured to handle a high volume of transaction processing. The central controller 200 also performs a significant number of mathematical calculations in processing communications and database searches. One example of a processor suitable for use as the CPU 205 is a Pentium microprocessor, such as the Single Quad-Core Intel Xeon 1200 2.4 GHz, commonly manufactured by Intel Inc. Equivalent processors include Dual-Core 64-bit AMD Opteron processors with 2x1MB L2 Cache 2.80 GHz commonly manufactured by AMD.

While the various systems may comprise executable software, each may include its own processor as well. For instance, the membership system 209, pricing system 210, REOO system 211, trading system 212, clearing system 213, and compliance system 214 may each have their own dedicated microprocessor (such as the Intel Xeon). Alternatively, these systems may be configured as part of the central CPU 205.

The membership system 209 authenticates the identity of real estate owners and investors. It uses a real estate owner database 255 and an investor database 260 to match identities of users that communicate with central controller 200. The pricing system 210 processes real estate owner and investor requests for pricing real estate options. Real estate owners provide real estate details 105 and receive one or more real estate options offers in return. Investors provide a real estate options query 138 and receive one or more real estate options meeting their query criteria in return.

The REOO system 211 facilitates creation of the REOO. The REOO system 211 further processes the sale of REOOs 110, purchase commitments 120 and sale commitments 125. This system provides all necessary operations for initial real estate options issue by parcel owner. The trading system 212 processes all investor trading on existing real estate options, including Investor Sale Offers (ISO) 140 and Investor Purchase Offers (IPO) 145.

The clearing system 213 processes all transactions which have a “pending” status. This system communicates with bank interface 180 to complete payment processing if needed. The compliance system 214 keeps track of every transaction by central controller 200, thus maintains a history of every transaction. This system also provides reports to real estate owners and investors on all of their activities and monitors for various compliance issues.

The data storage device 250, which may include hard disk, magnetic disk, optical storage units, CD-ROM drives, or flash memory, contains databases used in the processing of transactions. These databases include the real estate owner database 255, the investor database 260, the REOO database 265, the purchase and sale commitment database 268, the investor offers database 270, the real estate owner account database 275, the investor account database 276, the contract detail database 280, the payment database 285, the clearing database 290, and the audit database 295. In a preferred embodiment database software such as Microsoft SQL Server 2005, manufactured by Microsoft Corporation, is used to create and manage these databases.

The real estate owner database 255 maintains data on real estate owners with fields such as unique identifier, name, address, phone number, ID number, social security number, electronic mail address, credit history, past system usage, etc. This information is obtained when the real estate owner first registers with the system, or immediately prior to posting his first REOO 110.

The real estate owner account database 275 tracks all information pertaining to the real estate owner's account with fields such as real estate owner's name, bank and credit account numbers, and debit or credit transactions. Real estate owner payments for REOOs 110 may be sent to this database. This database may be a pointer to account data stored at the real estate owner's bank.

The investor database 260 maintains data on investors with fields such as unique identifier, name, contact information, real estate preferences. Contact information comprises a phone number, web page URL, blog address, pager number, telephone number, electronic mail address, voice mail address, facsimile number, or other contact indicia. Upon registration, the investor may be required to demonstrate evidence of a financial ability to purchase REOOs 110 or IPOs 145.

The investor account database 276 tracks all information pertaining to the investor's account with fields such as investor's name, unique identified, bank and credit account numbers. This database may be a pointer to account data stored at the investor's bank.

The REOO database 265 tracks all REOOs 110 with fields such as status, tracking number, date, time, price, expected parcel value, expiration date, conditions, and real estate owner identification number. This database is valuable in the event of disputes between real estate owners and investors regarding payment, because details of the offer can be produced.

The purchase and sale commitments database 268 tracks all purchase commitments 120 and sale commitments 125. The structure of this database is similar to REOOs database 265, plus the addition of a field for a REOO tracking number to facilitate purchase commitments 120 and sale commitments 125 being correlated with a particular REOO 110.

The investor offers database 270 tracks all ISOs 140 and IPOs 145. This database maintains data with fields such as real estate option identified, status, tracking number, date, time, amount, price, expected parcel value, expiration date, conditions, and investor identification number.

The contract detail database 280 contains form background provisions for inclusion in REOOs 110, ISOs 140 and IPOs 145. These form provisions effectively fill the details of conditions specified by the real estate owner, details of REOO, and specifying the generic contract details common to most REOOs 110. For an ISO 140 or an IPO 145, the contract detail database 280 fills in the details of conditions specified by the investor and the corresponding REOO 110.

The payment database 285 tracks all payments made by the investors with fields such as investor name, investor unique identifier, amount of payment, associated REOO 110, ISO 140 or IPO 145 tracking number. This database may also store bank account information of investors.

The clearing database 290 tracks all records of transaction between real estate owners and investors, investors and investors and status of the transaction. Records include fields such as unique identifier, amount of payment, and associated REOO 110, ISO 140, or IPO 145 tracking number.

The audit database 295 stores transactional information relating to the posting of REOOs 110, purchase commitments 120, sale commitments 125, ISOs 140, IPOs 145, and any other transaction processed by the central controller 200. This database allows such data to be retrieved for later analysis.

The escrow database 299 temporary holds investor funds before they are placed in the account of real estate owner in real estate owner account database 275. These funds may also be transferred from the escrow account database 299 to the investor account database 276.

The network interface 245 is the gateway to communicate with investors, real estate owners, and third parties 170 or third party systems such as the real estate information system 160, the bank interface 180, or the credit agency 190. Conventional internal or external modems, or network cards, may serve as the network interface 245. In one embodiment, the network interface 245 supports modems at a range of baud rates from 1200 upward, but may combine such inputs into a T1 or T3 line if more bandwidth is required. In one preferred embodiment, the network interface 245 is connected with the Internet and/or any of the commercial on-line services such as America Online, DSL, or Cable Internet, thereby allowing investors and real estate owners to access the system 100 from a wide range of on-line connections. The system 100, in one embodiment, is platform independent and utilizes open standards based on commonly understood Internet protocols. The system 100 also supports multiple languages. The system 100 may alternatively be configured as a voice mail interface, web site, bulletin board, or electronic mail address.

While the paragraphs above describe generally a single computer acting as central controller 200, it will be obvious to those of ordinary skill in the art having the benefit of this disclosure that system functionality can be distributed across a plurality of computers. In one embodiment, the central controller 200 is configured in a distributed architecture, where the databases and corresponding processors are housed in separate units or locations. Some controllers perform the primary processing functions and contain at a minimum RAM, ROM, and a general processor. Each of these controllers is attached to a WAN hub which serves as the primary communication link with the other controllers and interface devices. The WAN hub may have minimal processing capability itself, serving primarily as a communications router. Those skilled in the art having the benefit of this disclosure will appreciate that an almost unlimited number of controllers may be supported. This arrangement can yield a dynamic and flexible system, which may be less prone to multiple processor hardware failures.

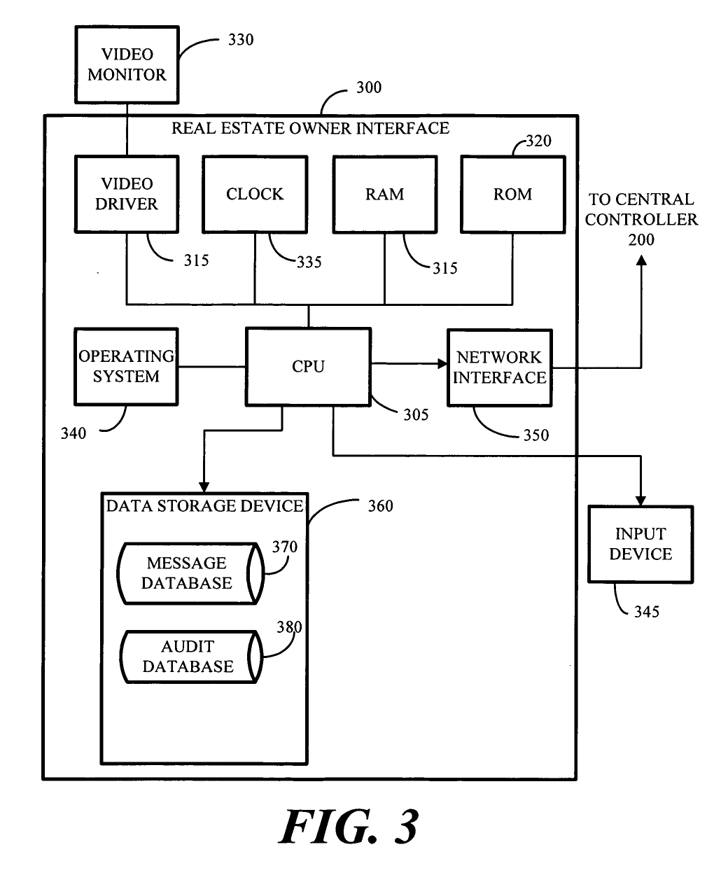

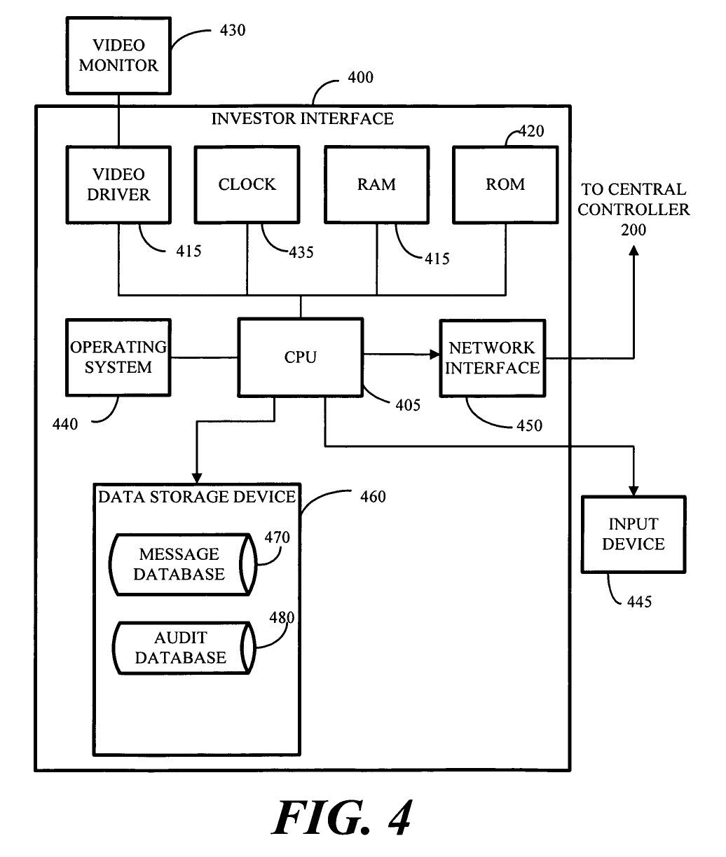

Turning now to FIGS. 3 and 4, illustrated therein are the real estate owner interface 300 and investor interface 400, respectively. In an exemplary embodiment, both the real estate owner interface 300 and the investor interface 400 comprise conventional personal computers having an input device, such as a keyboard, mouse, or conventional voice recognition software package; a display device, such as a video monitor; a processing device such as a CPU; and a network interface such as a modem or network card. These devices interface with central controller 200 across a network. Alternatively, real estate owner interface 300 and investor interface 400 may comprise other devices, such as voice mail systems, fax machines, pagers, PDAs, or other electronic or voice communications systems.

Referring to FIG. 3, the real estate owner interface 300 includes a central processor (CPU) 305, RAM 315, ROM 320, a clock 335, a video driver 325, a video monitor 330, an operating system 340, an input device 345, a network interface 350, and data storage device 360. A Xeon microprocessor such as the Intel Core 2 Duo E6700 described above may be used for CPU 305. The clock 335, in one embodiment, is a standard chip-based clock which can serve to timestamp a REOO 110, a purchase commitment 120 or a sale commitment 125.

The data storage device 360 is a conventional magnetic-based hard disk storage unit such as those manufactured by Maxtor. The message database 370 may be used for archiving REOOs 110, ISOs 140 and IPOs 145, while the audit database 380 may be used for recording payment records and communications with central controller 200.

Referring now to FIG. 4, the investor interface 400 includes a central processor (CPU) 405, RAM 415, ROM 420, a clock 435, a video driver 425, a video monitor 430, an operating system 440, an input device 445, a network interface 450, and a data storage device 460. All of these components may be identical to those described above in reference to FIG. 3.

Communications between the nodes and the central controller 200 may be enabled by various commercial software applications available today. Microsoft Outlook, manufactured by Microsoft Corporation, for example, provides editing tools for the creation of messages as well as the communications tools to route the message to the appropriate electronic address. When the central controller 200 is configured as a web server, conventional communications software such as the Internet Explorer web browser from Microsoft Corporation may also be used. The real estate owner interface 300 and investor interface 400 may use the Internet Explorer browser to transmit REOO 110, investor purchase commitments 120, sale commitments 125 or transaction confirmations 130.

In one embodiment of the invention, transactions between real estate owners and investors take place across a network, with the central controller 200 acting as a web server. The real estate owner logs on to the central controller 200 and creates a REOO as described above. The real estate owner then disconnects from the network. The central controller 200 makes the REOO available to potential investors by posting it on, for example, the web page of the central controller 200. The central controller 200 also performs periodic maintenance to ensure that active REOOs have not expired.

Investors transmit purchase commitments 120 or sale commitments 125 electronically to the central controller 200, which in turn saves them in the purchase and sale commitment database 268. Once a purchase commitment 120 or a sale commitment 125 for a given REOO have been validated, i.e. financially meets the price requested by the REOO, the central controller 200 clears the REOO 110 and transfers payments.

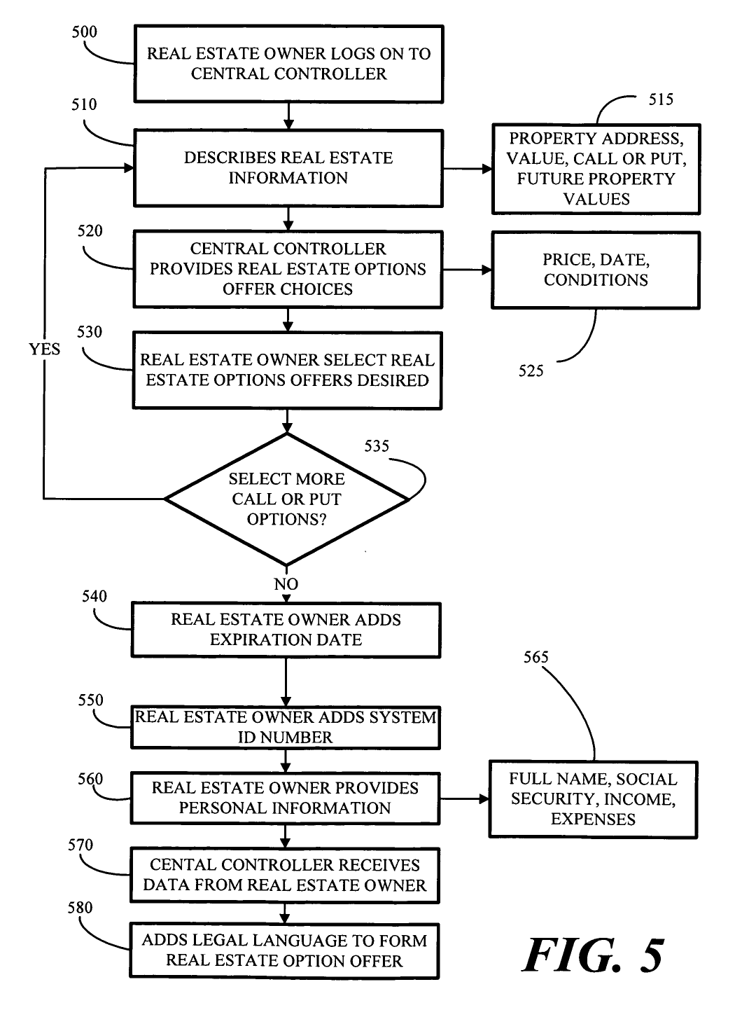

Turning now to FIG. 5, illustrated therein is one embodiment of a method by which the real estate owner formulates a REOO. At step 500, the real estate owner logs on to the central controller 200 by way of the real estate owner interface 300, thereby establishing a communication link. It should be noted that the real estate owner may be an individual, a corporation, a partnership, a government, or any other entity. In one embodiment, the central controller 200 provides a page on the World Wide Web, thereby allowing the real estate owner to communicate with the central controller 200 through the interface of conventional web browser software such as Internet Explorer, manufactured by Microsoft Corporation.

At step 510, the real state owner provides the real estate detailed information for the real estate upon which he wants to issue REOO. As shown in box 515, information might include property address, residential or commercial type, year purchased, current value, amount of existing debt, expected future property values, call or put option, etc. After the information is provided, a form is displayed on video monitor 430 of real estate owner interface 300.

At step 520, the real estate owner receives a list of options for REOOs available to him. These options are prepared by the pricing system 210 of the central controller 200. As shown in the box 525, offer options might include offer price, option expiration date, percentage share, and so forth. A homeowner, for example, might want to raise money for his daughter to go to college. If he owns a house that he purchased 20 years ago, he may use a REOO to extract funds from that parcel with sale of a call option. On the other hand the homeowner might want to insure against a price decline if his home value falls below a certain price with purchase of a put option. In accordance with one embodiment, he would enter his home address, last recorded property sale price and sale date, amount of any existing mortgage, his income, assets, expenses, etc. The real estate owner simply fills in the blanks. The real estate owner then reviews choices for real estate option offers 520 and chooses the one or more that most closely meets his needs. These options would be selected and the corresponding REOO generated.

As indicated in box 525, real estate options could include the provision that option can be re-purchased, option expiration date, price, percentage of share, and so forth which are conditions of the option. For example, the real estate owner at this step can elect whether to sell a partial interest in an option based upon the parcel, or an entire interest in the option. Said differently, where the REOO corresponds to a single real estate parcel, the option offer based on this parcel can be that of a partial interest in the option contract or an entire interest in the option contract. This determination will be used when the option contract is sold to investors.

Real estate option offer term and conditions may be modified so as to allow the real estate owner to tailor REOO for his specific needs. The REOO may also be based on one or more owner conditions. For example, one condition might state that four out of five other specified conditions must be met. Conditions may be based on external events. For example, the real estate owner may be required to obtain prior permission from the central controller 200 if he wants to refinance, sell or improve the parcel upon which options are sold or bought.

In another example, the real estate owner wants to command a higher price for options on a parcel. In such a scenario, real estate owner may issue a REOO that includes a real estate option with dividends.

The real estate owner selects REOO choices at step 530. At the step 535, if the real estate owner wants to select more call or put options to be associated with the REOO, he repeats the process starting at the step 510. If not, a next step is 540, where the real estate owner may add an expiration date to the REOO if desired. This expiration date option allows the real estate owner to post a REOO without worrying about being bound after a date certain, for example when his needs may have changed.

At step 550, the real estate owner attaches his name or a unique system identification number to the REOO. The central controller 200 provides the identification number when the real estate owner registers for the service. Alternatively, the real estate owner chooses the unique identification number and then registers with central controller 200 by phone. The central controller 200 maintains a list of the unique identification numbers in the real estate owner database 255. Where less security is required, the user's social security number could serve as the unique identification number, as it offers the advantages of being both unique and easily remembered.

At step 560, the central controller 200 may ask the real estate owner to provide additional personal information. As indicated in box 565, the personal information may include the real estate owner's full name, social security number, credit scores, income sources, asset information, expenses, and so forth.

The real estate owner then transmits the information to the central controller 200 at step 570. At step 580, boilerplate language is added to the REOO to complete the REOO. The boilerplate language is stored in the contract detail database 280.

As an alternative to the network interface, the real estate owner may also transmit REOO data via electronic mail, voice mail, facsimile, or postal mail transmissions. With voice mail, the real estate owner calls the central controller 200 and leaves REOO data in aural form. The REOO information may be transcribed into digital text at the central controller 200, or may alternatively be made available to potential investors in the aural format. In a mail enabled embodiment, the central controller 200 acts more like a router, directing REOOs to the potential investors, and creating multiple copies of REOOs when necessary. The REOOs may also be posted to bulletin boards or web pages operated by the central controller 200.

As noted, the central controller 200 supports a plurality of transmission methods, allowing for a wide variety of formats of REOOs. Some formats may be changed, however, before further processing by the central controller 200. By way of example, the REOOs may be transmitted by mail in paper form, may be scanned and digitized using optical character recognition software to create digital text. These embodiments are more fully described in the off-line embodiment described later.

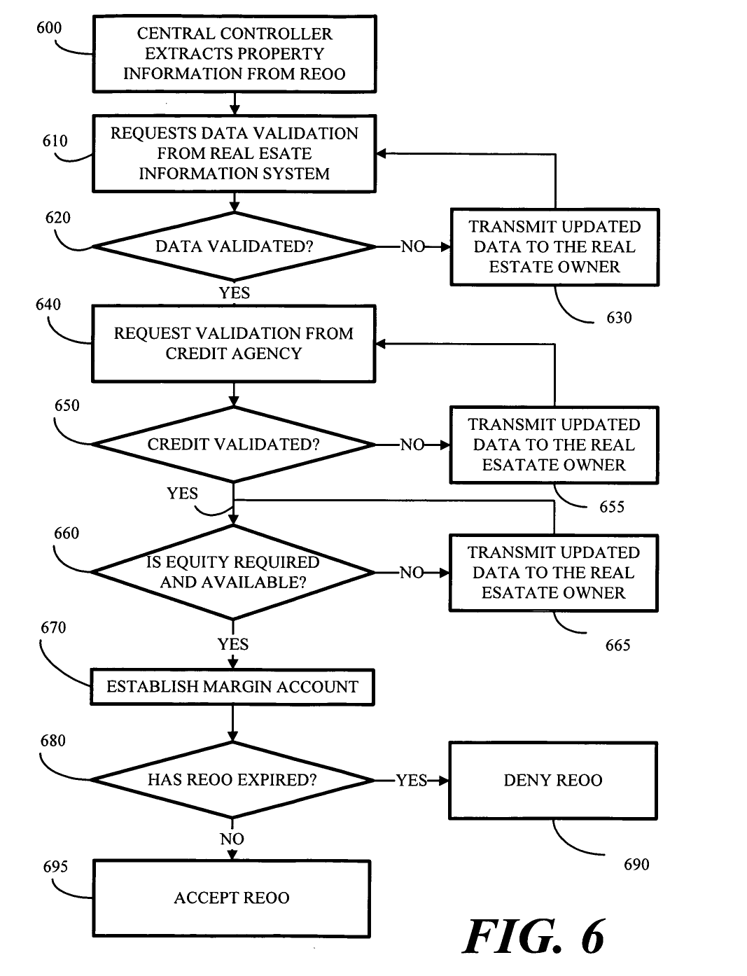

Referring now to FIG. 6, illustrated therein is a method of processing a REOO in the central controller 200 once the real estate owner has transmitted the REOO. When the REOO is received, the central controller 200 validates all information entered by the real estate owner to ensure that the monetary amounts and all conditions are justified. This occurs before the central controller 200 makes the REOO available to potential investors.

At step 600, the central controller 200 extracts real estate property information from the REOO. At step 610, central controller 200 submits property information for data validation to the real estate information system 160. One function of this submission is to validate the stated real estate value, existing debt, and property condition set forth in the REOO. The central controller 200 essentially checks to see if there is evidence to support the REOO assertions to investors.

At step 620, the real estate information system responds to the data validation, indicating whether all information has support evidence, or whether there is reason to believe that the information is inaccurate. If there is cause to believe that the information is not accurate, data supporting this cause is transmitted to real estate owner at step 630.

The real estate owner then has the opportunity to update the information or provide support for the original information. Where the REOO property information is updated or support is transmitted, central controller 200 then resubmits the request for data validation at step 610. At step 640, the central controller 200 requests a credit agency 190 to validate real estate owner personal information, such as social security, credit scores, debt, income and other information, which may be extracted from the REOO. At the step 650, if the personal information is not accurate as disclosed in the REOO, an indication of the inaccuracy is transmitted to real estate owner at step 655. As with the real estate information, the real estate owner has the opportunity to correct or validate the information. Once the real estate owner has validated or corrected the personal information, central controller 200 then resubmits the request for data validation to the credit agency 190 at step 640.

At the step 660, the central controller 200 validates if a margin account is required, such as in the case of a call option. If margin account is required, and sufficient property equity is available to cover the required amounts, the central controller 200 establishes margin account in the step 670. If the property equity is not sufficient to cover margin amount required as disclosed in the REOO, an indication of the amount shortage is transmitted to real estate owner at step 665. The real estate owner has the opportunity to correct or validate the information or alternatively to deposit cash in the amount required to establish margin account. Once the real estate owner has established required margin account, central controller 200 then resubmits the request for margin validation at step 660.

Other verification actions can occur at step 660 as well. For example, in one embodiment, the central controller 200 can take steps to prevent the real estate parcel owner from engaging in adverse behavior or manipulating future real estate payout options by permitting the sale of only a partial value of the REOO. In so doing, i.e., in selling a partial interest in the real estate parcel based option offer, the central controller 200 prevents the owner of the real estate parcel from manipulating a payout corresponding to the real estate parcel based option offer.

With the validation/correction processes transpiring, the central controller 200 may check the REOO to see if it has expired at step 690. If expired, the REOO is rejected at step 690 and returned to the real estate owner. If the REOO has not yet expired, it is accepted at step 695.

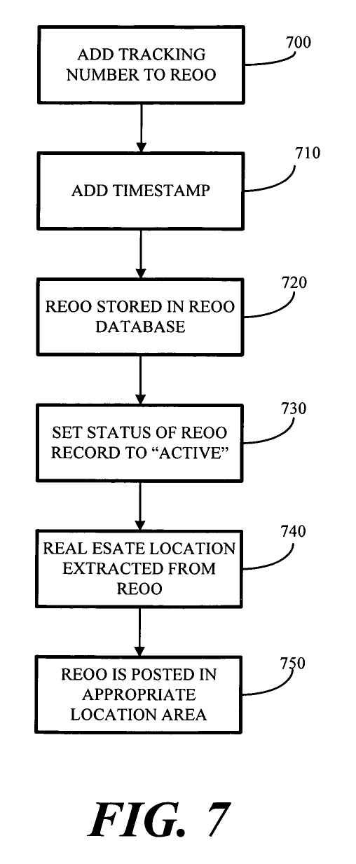

Referring now to FIG. 7, there is illustrated one method of activating and making public a REOO in accordance with embodiments of the invention. Specifically, the central controller 200 activates the REOO and makes it available to potential investors via the REOO system 211.

At step 700, a unique tracking number is added to the REOO. Additionally, the REOO system 211 timestamps the REOO at step 710 and stores the REOO in the REOO database 265. The REOO database 265, in one embodiment, contains a record for each REOO and includes fields such as status, property information, tracking number, timestamp, detail options offer, expiration date, conditions, and real estate owner ID number.

The status field, in one embodiment, has values of “pending,” “active,” “expired,” and “completed.” A status of “pending” means that the REOO is not currently available to potential investors. This may be the case because the REOO is either still being processed by central controller 200, or perhaps the real estate owner has temporarily suspended the REOO.

An “active” REOO becomes available to potential investors and can be bound. An “expired” REOO can no longer be bound. Once the entire REOO has been purchased by investors, the REOO is given a status of “completed.”

After being stored at step 720, the REOO may go through a series of processing steps. One step, if necessary, is language translation. Language translation may include either creating an equivalent REOO in a standard language for the system, or translating the REOO to a common language that is viewable by investors. Language experts at central controller 200 provide the translation. Alternatively, automatic translation software such as Systran Professional, manufactured by Systran Software, may be used. Many bi-directional language combinations are available, including English to/from French, Italian, German, Spanish, Portuguese, and Japanese. Another step, if necessary, is to edit for typographical and other errors. The central controller 200 may also again verify the information in the REOO with various third party systems 170.

At step 730, the status of the database record for the REOO is set to “active.” At step 740, the real estate location information of the REOO is extracted from the property information field. At step 750, the REOO is posted in an appropriate real estate location area. This allows, in one embodiment, the REOO system 211 to display the REOO only to the most appropriate investors. In a World Wide Web environment, the REOO system 211 has a web page for each real estate location or area. Thus, all REOOs for San Diego real estate, for instance, would be displayed on the San Diego web page. This presentation makes it much easier for potential investors to find appropriate REOOs, as they can go right to the real estate location of interest.

In an alternative embodiment, the REOO is electronically mailed to potential investors, either individually or in groups. Potential investors may optionally elect to receive all REOOs, only those REOOs in their real estate location area, or a subset of REOOs representing a particular investor specified condition. For example, an investor might request that all REOOs over $100,000 for San Diego be sent to them.

In embodiments where REOOs are being transmitted to investors, it is important to note that there are a number of hardware options for investor interface 400, some of which have been noted above in the description of FIG. 4. Suitable investor interfaces 400 include fax machines, PDAs with wireless connections, beepers, or pagers. For example, an investor in England may instruct the central controller 200 to “beep” him whenever a REOO appears for a New York property. The investor may request that the central controller 200 provide details of the REOO over the beeper network. Alternatively, the investor may request that the central controller 200 inform the investor to log on to the central controller 200 for further details.

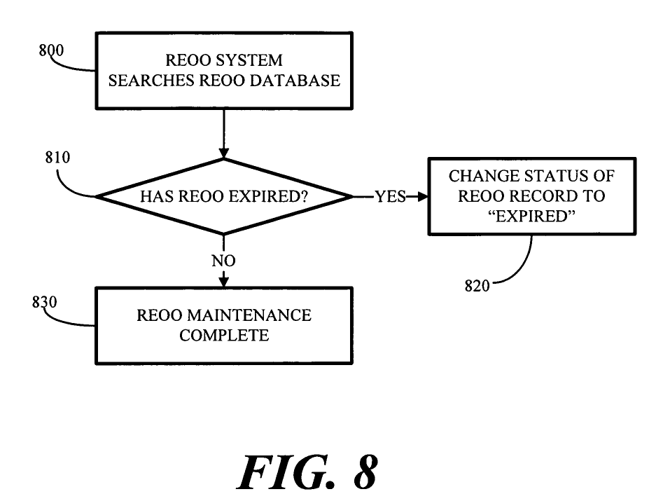

Turning now to FIG. 8, illustrated therein is one procedure for REOO maintenance in accordance with embodiments of the invention. At step 800, the REOO system 211 searches the REOO database 265. At step 810, the expiration date field of each database record is compared to the current date. If the expiration date of the REOO is earlier than the current date, the status of the REOO is changed to “expired” at step 820. The maintenance process is completed at step 830 once all “active” REOO database records have been examined.

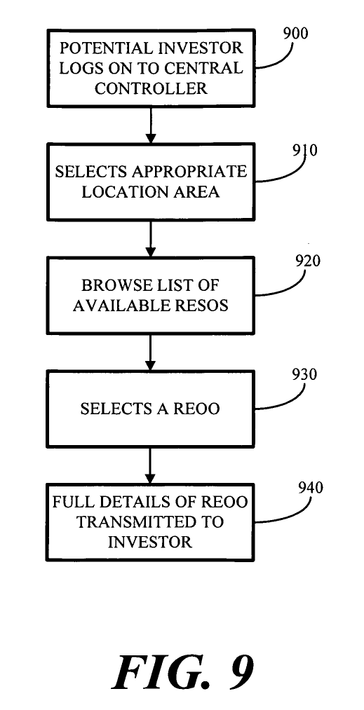

Turning now to FIG. 9, illustrated therein is one embodiment of a method by which a potential investor selects a REOO in accordance with the invention. At step 900, the potential investor logs onto the central controller 200 using the network interface 450 of the investor interface 400. At step 910, the potential investor selects an appropriate real estate location area. For example, an investor may select the Portland, Oreg. area when it is experiencing a real estate boom. As such, the investor may search the Portland real estate area in hope of finding an appropriate REOO.

At step 920, the potential investor browses the list of available REOOs (i.e. those with a status of “active”). The REOOs, in one embodiment, are listed with minimal details. Additional information is available where selected by the investor or where the potential investor is interested in purchasing a particular REOO. Continuing with the Portland, Oreg. REOO example from the preceding paragraph, a corresponding REOO might be listed as “Portland, Oreg.-50%-5 years-$100,000.”

At step 930 the potential investor selects a specific REOO. The potential investor may request additional data at step 940. In one embodiment, each REOO is hyperlinked to a separate web page. That web page may provide complete details or information. Upon accessing the web page, the potential investor may click on the REOO and be immediately transferred to a page or pages of supporting detail. This supporting detail may include a picture of the real estate parcel, historic price data for the area, sales statistics, comparable sales information, and so forth. In an alternate embodiment, the REOO is electronically transmitted directly to the investor. Transmission methods include electronic mail, fax, telephone, beeper, or other communication means.

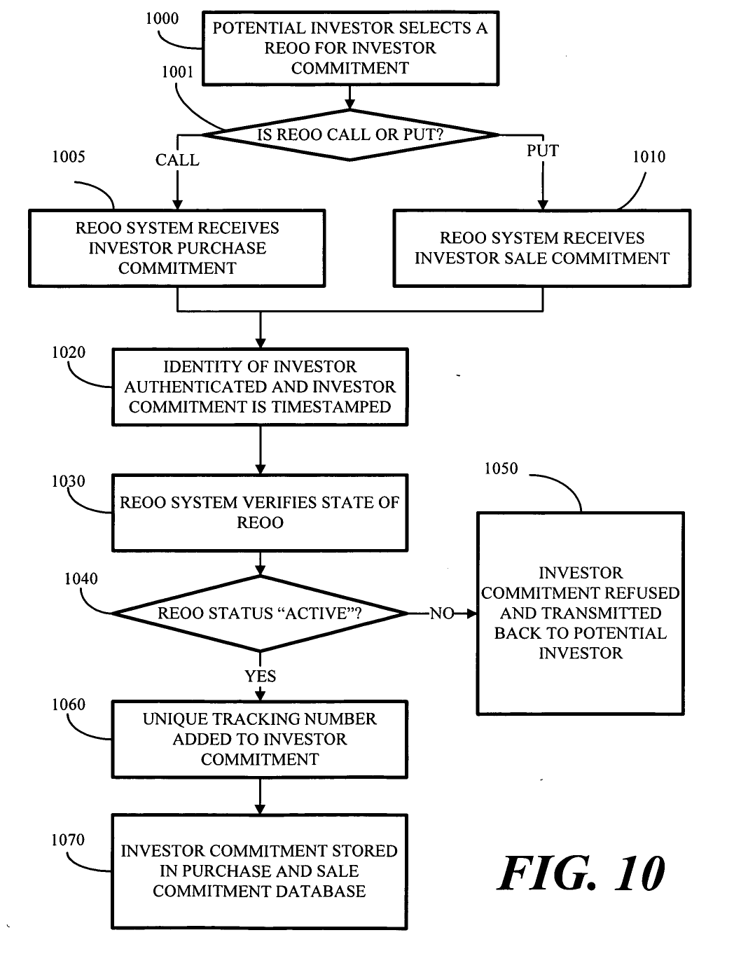

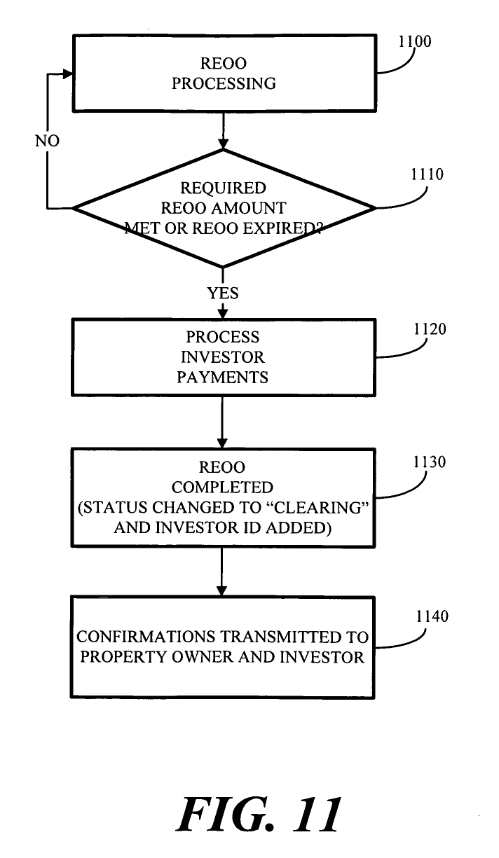

Turning now to FIGS. 10 and 11, illustrated therein is one method by which an investor participates in REOO in accordance with embodiments of the invention. At step 1000, the potential investor selects the REOO to be committed to. In step 1001, investor determines if the REOO is a call option or a put option. This selection generations an investor purchase commitment 120 representative of his intention to invest or an investor sale commitment 125 representative of his intention to insure. At step 1005, the REOO system 211 receives the investor purchase commitment 120 from the potential investor. At step 1010, the REOO system 211 receives the investor sale commitment 125 from the potential investor. The REOO system 211 then timestamps investor purchase commitment 120 or sale commitment 125 and authenticates the identity of the investor using membership system 209, as well as verifying his probable capacity to deliver the necessary funds at step 1020. The timestamp allows the REOO system 211 to determine the order in which investor purchase commitments 120 or sale commitments 125 are to be processed. If two investor purchase commitments 120 or sale commitments 125 are received within a few seconds of each other, the timestamp allows the REOO system 211 to decide which was received first. Alternatively, the timestamp may be appended to the investor purchase commitment 120 or sale commitments 125 at the time it is transmitted from investor interface 400, using the clock 435 of the investor interface 400.

Authentication of the investor's identity involves the central controller 200 extracting the unique system ID from investor purchase commitment 120 or sale commitments 125 and looking up the investor's identity in the investor database 260. Information in the investor database 260 then provides an indication of the investor's ability to deliver the required funds in case of purchase commitment 120 or a margin guarantee in case of sale commitment 125. Before an investor can complete an investor purchase commitment 120 in amount of $1,000, for example, central controller 200 must authenticate that the investor has $1,000 in available funds. On the other hand, before an investor can complete an investor sale commitment 120, for example, central controller 200 must authenticate that the investor has margin funds available to cover the payment in case of the payout. In one embodiment, the guarantee must be received by the central controller 200. Such a guarantee, which is for future payment upon expiration of the real estate option parcel based option offer, can comprise one of a property equity interest, cash, or a combination thereof. If necessary, central controller 200 may verify that the investor can provide the specific funds required by contacting the bank interface 180. In another embodiment, the investor incorporates the investor purchase commitment 120 or sale commitment 125 into the REOO. The investor may further sign the REOO by adding an electronic signature or other indication. This indication could be a digital signature, or could involve adding a symbol or indicia representative of the investor.

The REOO system 211 then verifies the status of REOO at step 1030, determining whether or not the status of the REOO is “active” at step 1040. If the REOO is currently “active,” a unique tracking number is added to the investor purchase commitment 120 or sale commitment 125 at step 1060. The REOO system 211 then stores investor purchase commitment 120 or sale commitment 125 in the purchase and sale commitment database 268 at step 1070. If the status of REOO is not “active” at step 1040, the central controller 200 refuses the investor purchase commitment 120 or sale commitment 125 and transmits the investor purchase commitment 120 or sale commitment 125 back to the potential investor at step 1050.

Turning now to FIG. 11, illustrated therein is one embodiment of a REOO completion process in accordance with embodiments of the invention. The REOO completion process begins at REOO processing step 1100. The central controller 200 checks the validity of the REOO at step 1110. The central controller 200 processes payments when sufficient amount of investor purchase commitments 120 or sale commitments 125 have posted for a specific REOO, or where the REOO reached the expiration date. The central controller 200 may additionally process payments where the real estate owner has agreed to any amount less than the original REOO amount. In such a case, the REOO may retain its status of “active” until a sufficient number of investors have responded. Once a sufficient number of investors have responded, the status of the REOO is changed to “clearing.”

At step 1120, the clearing system 213 processes the investor payment information and the approval code for the selected REOO in case of purchase commitment 120. This information and approval code is transmitted to the bank interface 180 for a withdrawal of funds initiated by investor when completing the investor purchase commitment 120. On the other hand, the clearing system 213 processes the property owner information and the approval code for the selected REOO in case of sale commitment 125. Once the payment transfer is completed at step 1130, the REOO is completed and bound, and the REOO has become an option contract between the real estate owner and investor. The binding process requires that the status of REOO 110 be changed to “completed,” thereby preventing subsequent investors from committing to already sold REOOs. The binding process also requires that the unique investor identifier be added to the REOO. At step 1140, the central controller 200 sends a transaction confirmation 130 to the investor and real estate owner.

In accordance with embodiments of the invention, there are many methods by which the provider of the system may generate revenue. In one embodiment, a flat fee is charged for every REOO that is submitted. There may also be flat fees for a predetermined number of REOOs submitted within a given period of time, thereby allowing investors to subscribe to the service much in the same manner as they might subscribe to a newspaper.

In another embodiment, the central controller 200 calculates a percentage of the amount paid by investors or received by real estate owners. Upon calculation, the central controller 200 may actuate a program to retain that percentage amount. Alternatively, methods and apparatuses of the present invention may be deployed without a payment feature.

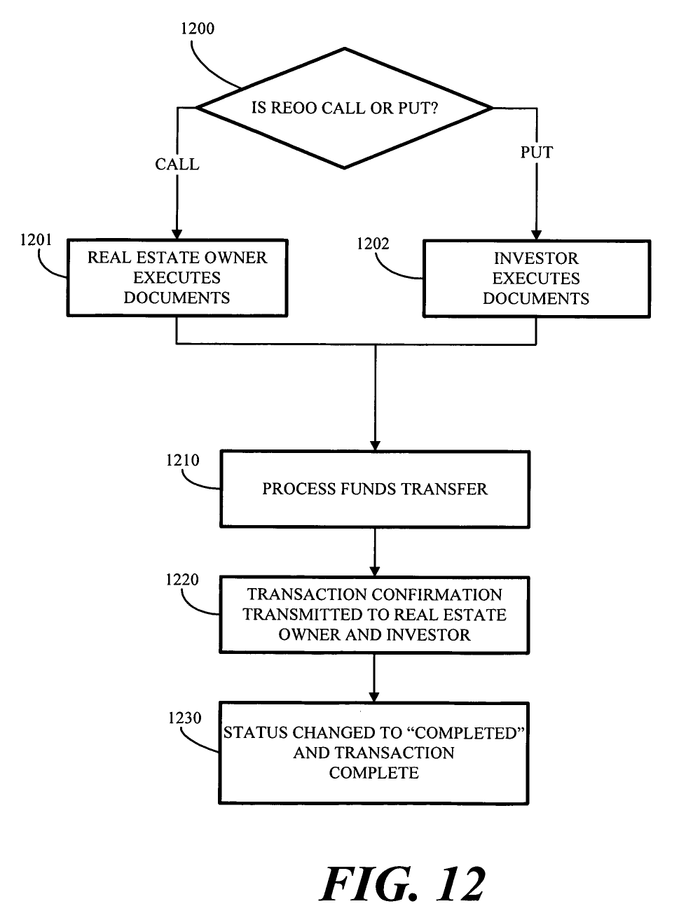

Turning now to FIG. 12, illustrated there are the remaining steps of REOO process completion. In the case of the investor purchase commitment 120, at step 1200, the real estate owner signs binding documents specified by the REOO terms and conditions at step 1201. In the case of the investor sale commitment 125, at step 1200, the investor signs binding documents specified by the REOO terms and conditions at step 1202. At step 1210, payment information and an approval code are processed by clearing system 213 and transmitted to the bank interface 180 for deposit of funds. At the step 1220, the central controller 200 sends transaction confirmation 130 to the real estate owner and the investor. At step 1230, the status of the REOO is changed to “completed” and the transaction is complete.

In one embodiment of the invention, communications between investors take place across electronic networks, with the central controller 200 acting as a liaison, broker, or communication web server. To provide liquidity for real estate options sold through the system, embodiments of the invention provide investors with a mechanism for selling the real estate options at any time. To sell or buy options, the investor first logs on to the central controller 200 and creates an investor sale offer (ISO) 140 or investor purchase offer (IPO) 145. The ISO or IPO is then made available to potential investors by posting on a web page presented by the central controller 200. The central controller 200 may additionally provide periodic maintenance to ensure that active ISOs or IPOs have not expired. The central controller 200 may monitor the ISOs and IPOs for matches. Where a match is found, the central controller 200 completes transfer of real estate options from one investor to another. The central controller 200 additionally transfers payments between buyers and sellers at the time of real estate options transfer.

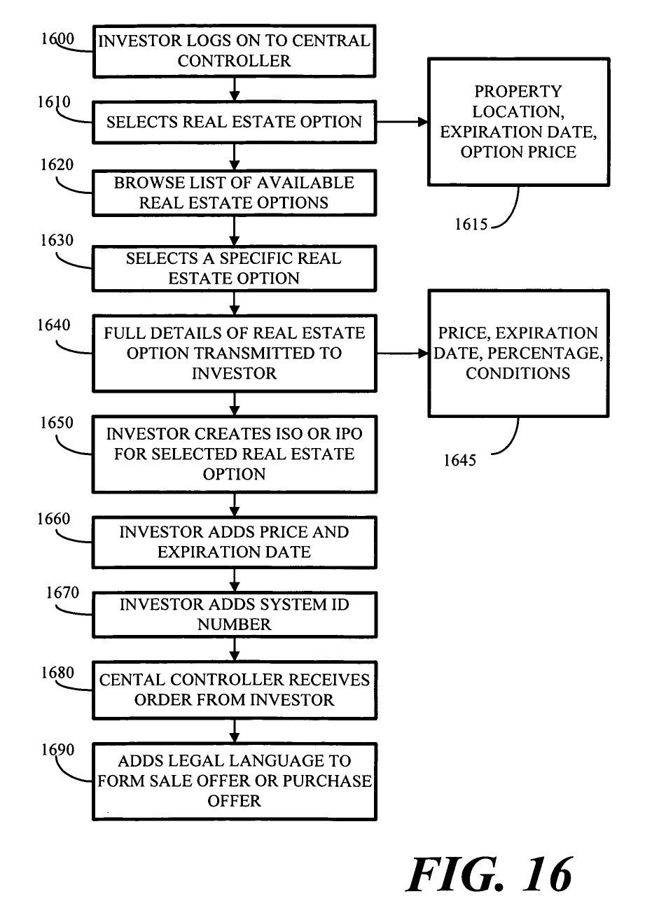

Turning now to FIG. 16, illustrated therein is one method by which an investor formulates the ISO or the IPO in accordance with embodiments of the invention. At step 1600, the investor logs on to the central controller 200 using the investor interface 400, thereby establishing a communication link with the central controller 200. It should be noted that the investor may be any of an individual, a corporation, a partnership, a government, or other entity. In one embodiment, the central controller 200 has a page on the World Wide Web, thereby allowing the investor to provide information through the interface of conventional web browser software such as Internet Explorer, manufactured by Microsoft Corporation.

At step 1610, the potential investor selects an appropriate real estate option using real estate option query 138. An investor, for example, who lives in Boston and wants to diversify his real estate investment portfolio, may wish to invest $10,000 into residential real estate located in Austin, Tex. At step 1620, this potential investor browses the list of available real estate options in the Austin area. Real estate options may be listed with minimal details, with additional information available only where the potential investor requests such information. An Austin, Tex. real estate option might be listed as “Austin, Tex.-50%-Jan. 15, 2017-$12500.” As shown in box 1615, the investor may search real estate options in accordance with a multitude of parameters. These parameters may include property address, residential or commercial description, contract expiration date, parcel value, option price, and so forth.

At step 1630 the potential investor selects a specific real estate option. Where additional information is required, the investor may request such additional data at step 1640. In one embodiment, each real estate option listing is hyperlinked to a separate web page that provides complete parcel/option details. This detail may include a picture of the underlying real estate parcel, historic price data for the area, ISOs and IPOs open for that option, and so forth. In another embodiment, real estate option details are electronically transmitted directly to the investor. Transmission means include electronic mail, fax, telephone, beeper, or other communication devices.

As indicated in box 1645, the real estate option listing may include a provision that the option can be re-purchased. Additionally, the listing may include a contract expiration date, a total option contract amount, a percentage of payoff share, or other terms that constitute conditions or covenants of the real estate option. Such conditions may have been defined when the REOO was issued.

In one embodiment, the pricing system 210 provides investors with an accurate price of the specific option. In order to price the option, the pricing system 210 needs a derived value of the real estate parcel. To establish the price of the real estate parcel at any given time, in one embodiment the pricing system 210 uses a weighted combination of one or more local real estate price indexes and provided by automated valuation system from the real estate information system 160. When original REOO was issued, the value of the property is partially derived based on a last record sale of the real estate parcel and adjusted based on change in one more local real estate price indexes and partially based on value derived by automated valuation system. The derived value, in one embodiment, defines an unbiased starting point for deriving the future value of the property at later time. Over the term of the option a derived price of the parcel will fluctuate.

At step 1650, the investor chooses to issue either the ISO or the IPO for a specific real estate option. After the necessary information has been provided, a form is displayed on the video monitor 430 of the investor interface 400. This form is an electronic contract with a number of blanks to be filled out by investor. Each blank represents a condition of the ISO or the IPO. The investor simply fills in the blanks.

At step 1660, the investor adds an expiration date, amount and price to the ISO or the IPO, if desired, or chooses to execute transaction at prevailing price. This selection allows the investor to post the ISO or the IPO without worrying that he will later be bound when needs may have changed or his offer price has not been matched.

At step 1670, the investor attaches his name or a unique system ID number to the ISO or the IPO. This unique system ID, in one embodiment, is received from central controller 200 when the investor registers for the service. Alternatively, the unique system ID is chosen by the investor and then registered with central controller 200 by phone. The central controller 200 maintains a database of investor unique system ID numbers in the investor database 260, and issues (or allows) only unique numbers. If less security is required, the investor's social security number could serve as the unique ID number since it has the advantages of being both unique and easily remembered.

The investor then transmits the identifier to the central controller 200 at step 1680. The investor does this by clicking a “send” button located on the screen. At step 1690, boilerplate or form language is added to the ISO or IPO to complete them. The boilerplate language is pulled from the contract detail database, which stores such paragraphs.

As an alternative to a networked interface, such as a World Wide Web-based interface, the investor may also transmit the ISO or the IPO data via electronic mail, voice mail, facsimile, or postal mail transmissions. With a voice mail embodiment, the investor calls central controller 200 via telephone and leaves the ISO or the IPO in audio form. The ISO or the IPO may be transcribed into digital text at the central controller 200, or may be made available in audio format. In a postal mail embodiment, the central controller 200 acts more like a router, directing the ISO or the IPO to the potential investors, thereby creating multiple copies of the ISO or the IPO if necessary. The ISO or the IPO may also be posted to bulletin boards or web pages operated by central controller 200.

In one embodiment, the central controller 200 supports a plurality of transmission methods, allowing for a wide variety of electronic IPO or ISO formats. Some formats may be changed, however, before further processing by central controller 200. For instance, the ISO or the IPO may be transmitted by mail in paper form, or may be scanned-in and digitized using optical character recognition software to create digital text.

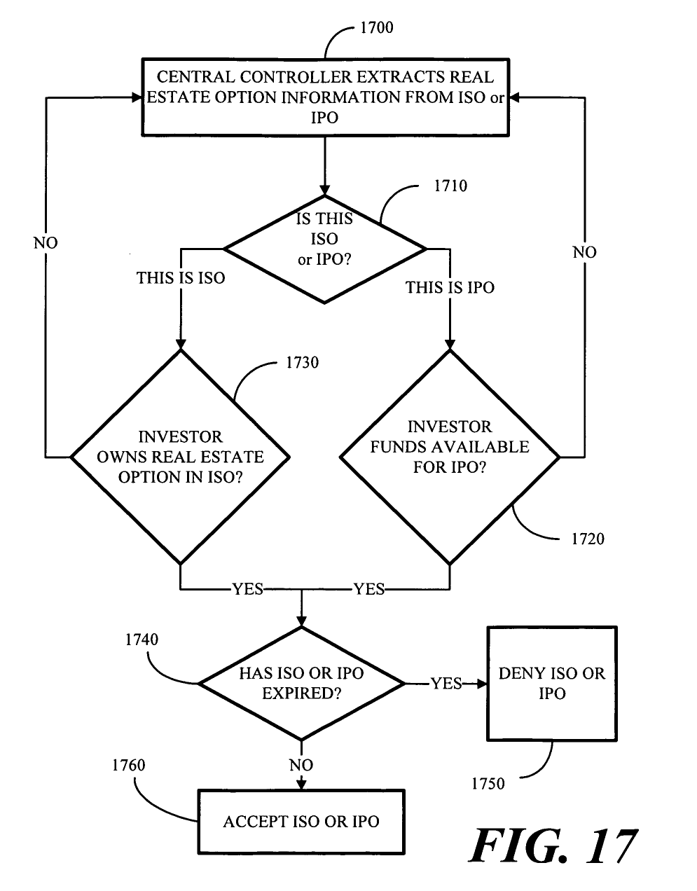

Referring now to FIG. 17, illustrated therein is a method of validating and publishing the ISO or the IPO in accordance with embodiments of the invention. At step 1700, the central controller 200 extracts real estate option information from the ISO or the IPO. At step 1710, the central controller 200 chooses a validation path based on type of ISO or IPO. If offer is an IPO, the central controller 200 validates whether the necessary funds are available in the investor account at step 1720. If funds are not available to cover amount in the IPO, a balance amount required to complete the transaction is transmitted to the investor at step 1720. Once additional funds have been deposited, and the ISO or the IPO is updated and transmitted, the central controller 200 then resubmits the request for validation at step 1700.

If the offer is an ISO, the central controller 200 validates whether the investor owns the real estate option, and whether it is available in an account at step 1730. If the investor does not own the corresponding real estate option, or if the corresponding real estate option is not available in the investor account, notice of such is transmitted to investor at step 1730. Once the necessary real estate option is deposited and the ISO is updated and transmitted, the central controller 200 resubmits the request for validation at step 1700. Additionally, the ISO or the IPO is checked to see whether expiration has occurred at step 1740. If expired, the ISO or the IPO is rejected at step 1750 and returned to the investor. If the ISO or the IPO has not yet expired, it is accepted at step 1760.

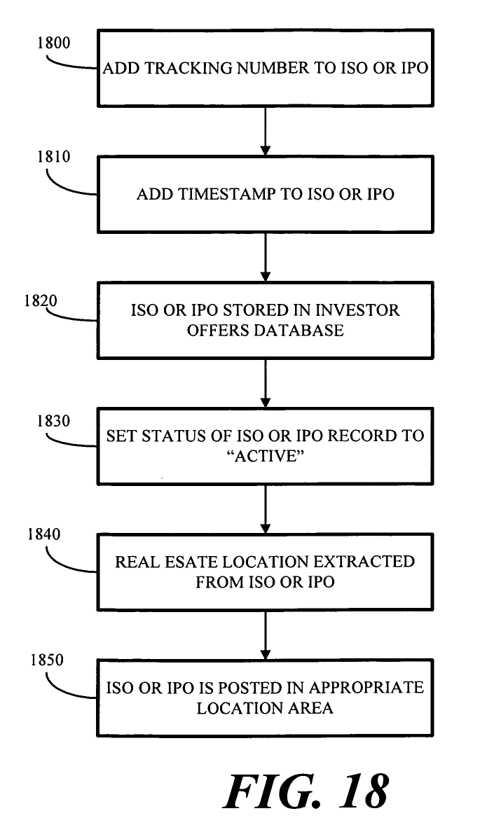

Turning now to FIG. 18, illustrated therein is one embodiment of a method with which an ISO or an IPO is activated and published in accordance with the invention. At step 1800, a unique tracking number is added to the ISO or the IPO. The central controller 200 timestamps the ISO or the IPO at step 1810, and then stores the ISO or the IPO in the investor offers database 270. The investor offers database 270 contains a record for each ISO or IPO, and includes fields such as status, real estate option information, tracking number, timestamp, amount, price, expiration date, conditions, and original REOO unique ID number if available.

The status field has values of “pending,” “active,” “expired,” and “completed.” A status of “pending” means that the ISO or the IPO is not currently available to other investors. This may be the case while central controller 200 is still processing the ISO or the IPO, or where the investor has temporarily suspended the ISO or the IPO. An “active” ISO or IPO is available to other investors and can be executed. An “expired” ISO or IPO can no longer be bound. Where investors have completed the ISO or the IPO, the status is marked “completed.”

The status of the database record for the ISO or the IPO is set to “active” at step 1830. At step 1840, the real estate location information of the ISO or the IPO is extracted from the real estate property information field. At step 1850, the ISO or the IPO is posted in an appropriate real estate location area. This posting allows the central controller 200 to display the ISO or the IPO only to the most appropriate investors.

In an on-line, networked environment, such as a World Wide Web environment, the central controller 200 has a web page for each possible real estate location area. Thus all ISOs or IPOs for San Diego, Calif. properties may be displayed on a corresponding San Diego web page. This makes it much easier for potential investors to find appropriate ISOs or IPOs as they are able to go precisely to the real estate location of interest.

In an alternative embodiment, the ISO or the IPO is electronically mailed to potential investors, either individually or in groups. Potential investors may elect to receive all ISOs or IPOs. Alternatively, the potential investors may elect to receive only those ISOs or IPOs in a pre-requested real estate location. Investors may elect to receive only a subset of ISOs or IPOs representing a particular condition. For example, an investor might request that all ISOs or IPOs under $100 in the greater metropolitan San Diego area be sent to them.

Where ISOs or IPOs are being transmitted to investors, it is important to note that there are a number of hardware options suitable for the investor interface 400, some of which have already been recited. Some suitable investor interfaces 400 include fax machines, PDAs with wireless connections, beepers, or pagers. For example, an investor in England could instruct the central controller 200 to beep him whenever an ISO or IPO appeared for a New York property. The investor may further request that details of the ISO or the IPO be transmitted over the beeper network. The investor may request that a notice informing the investor to log on to the central controller 200 be sent as well.

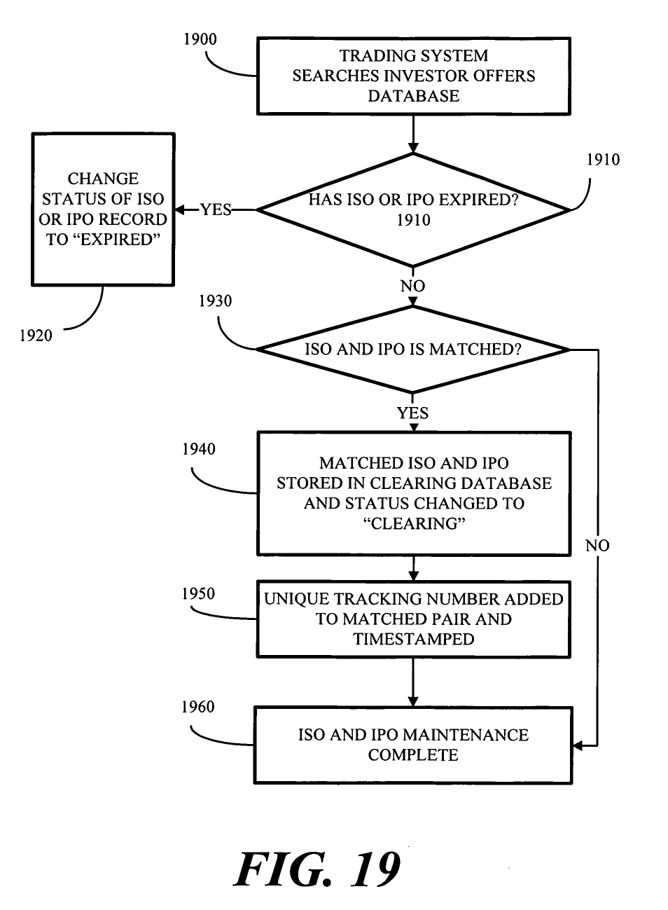

Turning now to FIG. 19, illustrated therein is one method of maintaining ISOs or IPOs in accordance with embodiments of the invention. At step 1900, the trading system 212 searches the investor offers database 270. At step 1910, the expiration date field of each database record is compared to the current date. If the expiration date is earlier than the current date, the status of the ISO or the IPO is changed to “expired” at step 1920.

At step 1930, the trading system 212 attempts to match “active” ISO to “active” IPO, and vice versa. If match is found, at step 1940 the trading system 212 records the ISO or the IPO match in the clearing database 290. Where an entire amount requested by the ISO is covered by the IPO, the status of the selected ISO and IPO are changed to “clearing” status. Otherwise the ISO amount is reduced by IPO amount.

A new record stored in the clearing database 290 receives a unique tracking number and timestamp at step 1950. The new record is marked “open”. The timestamp allows the central controller 200 to determine the order in which clearing should be processed. If two ISO and IPO matches are found within a few seconds of each other, the timestamp allows the central controller 200 to decide which was first. If no match is found, the trading system 212 proceeds to step 1960. The maintenance process is completed at step 1960 once all “active” ISOs or IPOs database records have been examined.

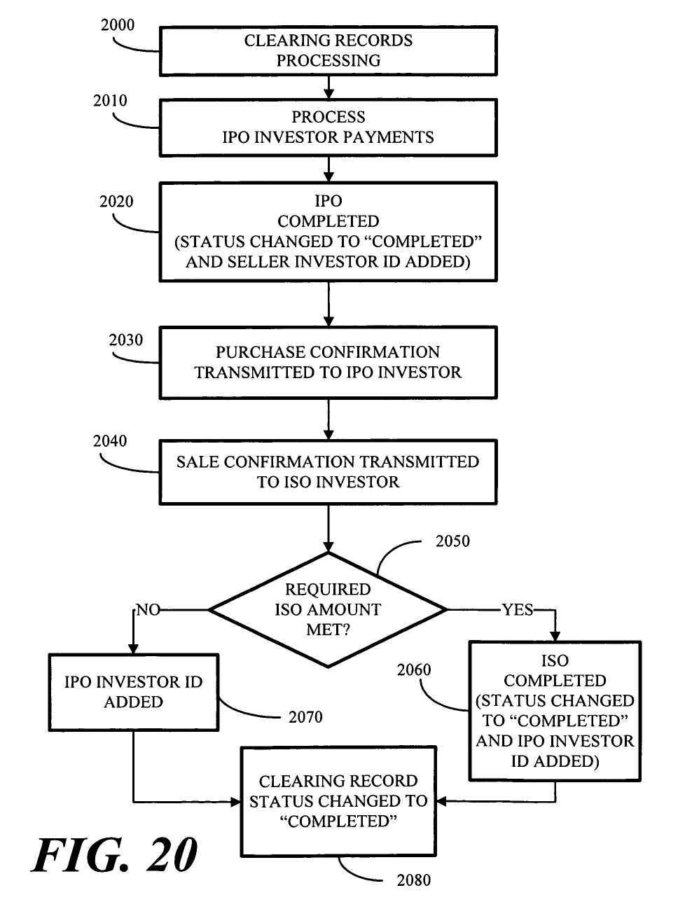

Turning now to FIG. 20, illustrated therein is a process by which matched clearing records in the clearing database 290 are processed in accordance with embodiments of the invention. The completion process begins at step 2000. This process clears records that have a status of “open.”

At step 2010, buyer payment information and an approval code for the selected clearing record is processed by the clearing system 213. Additionally, funds are transferred from the buyer account to the seller account. Once payment transfer is completed, at step 2020 the clearing record is completed and the IPO is bound, turning the IPO into a legally binding contract between the investors in the transaction. At step 2030, the clearing system 213 sends a transaction confirmation 130 to the investor. A sale confirmation 150 is then sent by the clearing system 213 to the investor at step 2040. At step 2050, the central controller 200 verifies whether the amount requested by the ISO has been met. If the entire ISO amount has been covered by the IPO, then the ISO status is changed to “completed” and the appropriate investor unique ID number is added to the underlying REOO.

The binding process requires that the status of the IPO be changed to “completed.” The binding process also requires that the corresponding IPO investor unique ID number be changed on the corresponding REOO to reflect a new owner of the real estate option. If only a partial amount of the amount requested by the ISO is covered by the IPO, the central controller 200 at step 2070 adds the appropriate IPO investor unique ID number to the REOO record associated with the ISO. At step 2080, the clearing record status is changed to “completed.”

As with the REOO system, there are many methods by which the providers of the ISO and IPO system might generate revenue. In one embodiment, a flat fee is charged for every ISO or IPO that is matched. There may also be flat fees charged to cover a predetermined number of ISOs or IPOs over a given period of time, thereby allowing investors to subscribe to the service much as they would subscribe to a newspaper. In another embodiment, the central controller 200 calculates a percentage of the amount paid by investors. In such a scenario, the central controller 200 retains a percentage of that amount. Alternatively, the method and apparatus of the present invention may be employed without a payment feature.

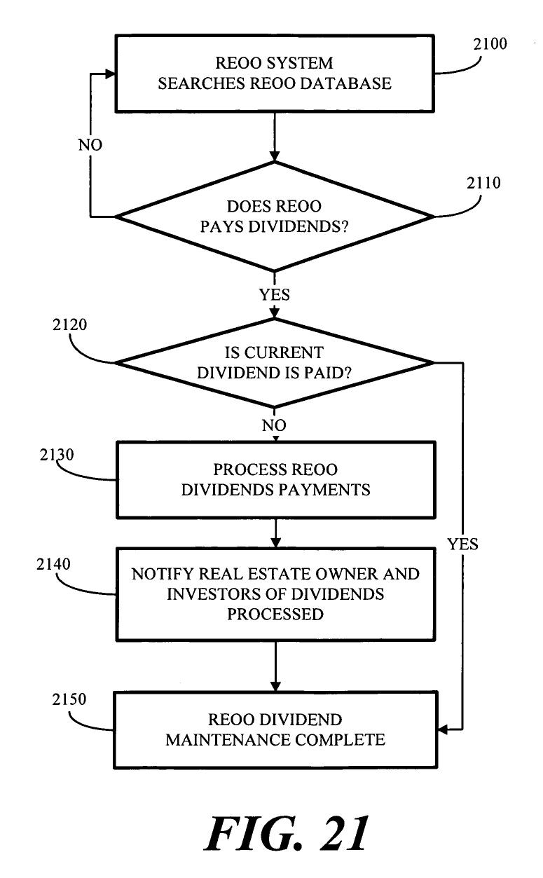

Turning now to FIG. 21, illustrated therein is one method for processing dividend payments in accordance with embodiments of the invention. Such dividends may be associated with the particular REOO. At step 2100, the REOO system searches the REOO database 265 for REOOs that pay dividends. At step 2110, the REOO system 211 confirms whether a selected REOO pays dividends. If no dividends are paid with a REOO, the REOO system 211 returns to step 2100 and continues searching the REOO database 265. If dividend payments are required, at step 2120 the REOO system 211 checks to see if current dividends have been paid. If the required dividends have been paid, at step 2150 the REOO dividend maintenance process is complete. If dividends were not paid, at step 2130 the REOO system 211 processes the REOO dividend payments by withdrawing money from the real estate owner account database 275 and depositing it into accounts of the appropriate investors on record with the REOO in the investor account database 276. At step 2140, REOO system 211 notifies real estate owner of REOO 110 and investors on record of dividends processed. At step 2150, REOO 110 dividends maintenance is complete.

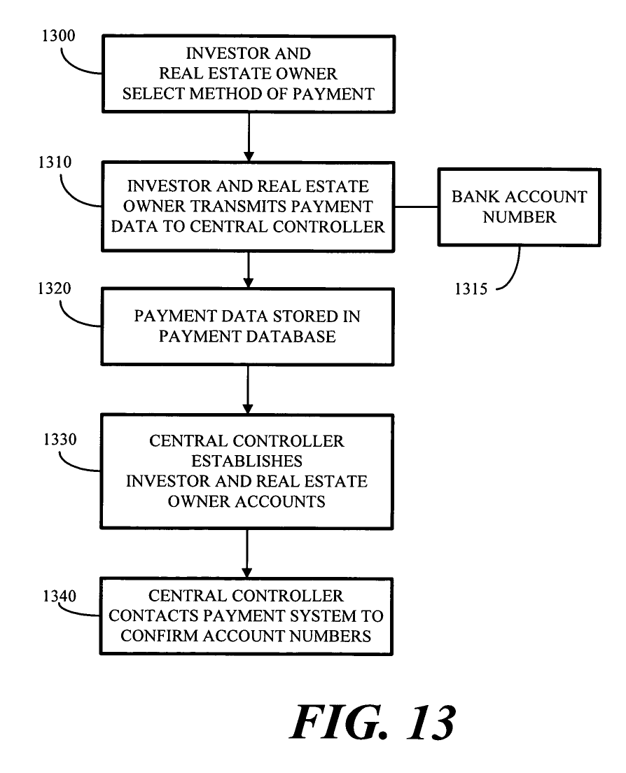

Turning now to FIG. 13, illustrated therein is one embodiment of a method by which the central controller 200 establishes the investor account database 276 and real estate owner account database 275 in accordance with the invention. At step 1300, the investor or real estate owner selects his preferred method of payment. Preferred methods might include personal checks, electronic bank funds transfer, digital money, and so forth. At step 1310, the investor or real estate owner transmits payment data corresponding to his preferred method of payment to the central controller 200. As indicated at step 1315, such payment data might include bank account number. These payment methods are merely illustrative. It will be clear to those of ordinary skill in the art having the benefit of this disclosure that many equivalent payment methods may also be used. If the investor or real estate owner wants to pay by debit card, for example, payment data would include his debit card account number, expiration date, name on the card, and security pin. For electronic funds transfer, payment data includes bank information and an account number. At step 1320, the central controller 200 stores payment data and payment preferences in payment database 285.

At step 1330, the central controller 200 establishes the investor account database 276 and the real estate owner account database 275. These databases are used to store money transferred by the investor or real estate owner. The databases may include a pointer to an account belonging to the investor or real estate owner that exists outside the system. The investor may transfer money to the central controller 200 to be stored in investor account database 276, which would operate like a conventional checking account. The central controller 200 sends a check to the real estate owner that is written against investor account database 276. Alternatively, the central controller 200 may electronically move the funds directly from the investor account database 276 to the real estate owner account database 275.

At step 1340, the central controller 200 contacts the payment system to confirm that account numbers are valid. An investor is thus unable to make investor purchase commitments 120 with no credit available in the investor account database 276. Account information may also be embedded in the REOO, the investor purchase commitment 120 or the investor sale commitment 125, thereby allowing the central controller 200 to complete payment once REOO 110 is completed.

Another method of payment involves procedures using digital cash. The central controller 200 looks up the investor's electronic delivery address in the payment database 285. This address is transmitted to the clearing system 213, with the digital cash being downloaded from the investor. The central controller 200 updates the payment database 285 to indicate that payment has been made. This address might be an electronic mail address if the digital cash is to be transferred by electronic mail, or it may alternatively be an Internet Protocol address capable of accepting an on-line transfer of digital cash. This electronic delivery address is sent to the clearing system 213. The digital cash is downloaded to the investor account database 276 or directly to the investor. The central controller 200 then updates payment database 285 to indicate that payment has been made. Using these digital cash protocols, it is possible for the investor to include payment along with investor purchase commitment 120 in electronic form. The practice of using digital cash protocols to effect payment is well known in the art and need not be described here in detail. For reference, refer to Daniel C. Lynch and Leslie Lundquist, Digital Money, John Wiley & Sons, 1996; or Seth Godin, Presenting Digital Cash, Sams Net Publishing, 1995.

While the networked, on-line embodiments of the invention describe a protocol in which investors make payment immediately upon making a purchase commitment 120 or real estate owners make payment immediately upon accepting an investor sale commitment 125, other embodiments may be implemented where payment is delayed until the REOO has been completed. Alternatively, payment may be delayed until some predetermined date. Partial payments and installment payments are also supported by the system.

The escrow account database 299 allows payment to be delayed until the REOO, ISO or IPO is completed. This delay may occur while the real estate owner completes delivery of the REOO, or while the investor completes delivery of real estate option and funds. The central controller 200 establishes records in the escrow account database 299 as temporary holding records. When the investor makes purchase commitment 120 for a REOO, funds are transferred from the investor account database 276 to the escrow account database 299. Only after the real estate owner executes the REOO are funds transferred from escrow account database 299 to real estate owner account database 275. The investor may transmit a digitally signed release message to the central controller 200, thereby authorizing the release of the escrowed funds to the real estate owner. On the other hand, when the real estate owner accepts in investor sale commitment 125 for a REOO, funds are transferred from the real estate owner account database 275 to the escrow account database 299. Only after the investor executes the REOO are funds transferred from escrow account database 299 to investor account database 276. The real estate owner may transmit a digitally signed release message to the central controller 200, thereby authorizing the release of the escrowed funds to the investor.

In another embodiment, the investor makes a partial payment when the purchase commitment 120 for a REOO made. The investor then completes payment when the REOO is completed. The fraction of the offered price of the REOO, in one embodiment, is to be paid upon binding the purchase commitment 120. The price is stored in the payment database 285 when the purchase commitment 120 is bound. The central controller 200 releases this portion of the funds at step 1120, and then releases the remaining portion after the REOO is completed at step 1201. The partial payment made may be non-refundable. This would allow the central controller 200, for example, to accept other investor purchase commitments 120 as back up commitments.

In similar way, the real estate owner makes a partial payment when the investor sale commitment 125 for a REOO is made. The real estate owner then completes payment when the REOO is completed. The fraction of the offered price of the REOO, in one embodiment, is to be paid upon binding the sale commitment 125. The price is stored in the payment database 285 when the sale commitment 120 is bound. The central controller 200 releases this portion of the funds at step 1120, and then releases the remaining portion after the REOO is completed at step 1202. The partial payment made may be non-refundable. This would allow the central controller 200, for example, to accept other investor sale commitments 125 as back up commitments.

In yet another embodiment, the purchase commitment 120 or sale commitment 125 describes the use of installment payments. The first payment is made when purchase commitment 120 or sale commitment 125 is bound, followed by regular payments as specified in the conditions of the REOO. The dates at which payments are to be made are stored in the payment database 285.

In one embodiment of the present invention, investors respond to the REOO not by binding it, but by making a counteroffer with modified and/or additional conditions. An investor, for example, might view a REOO offered at one hundred thousand dollars. The investor may be willing to make purchase commitment for ninety thousand dollars. As such, rather than passing on the REOO, the investor may wish to issue a counteroffer. This counteroffer is similar to the REOO except for the fact that the investor is binding the real estate owner instead of the real estate owner binding the investor. The counteroffer is also directed to a specific party (the real estate owner), unlike the REOO that is directed to a plurality of investors.

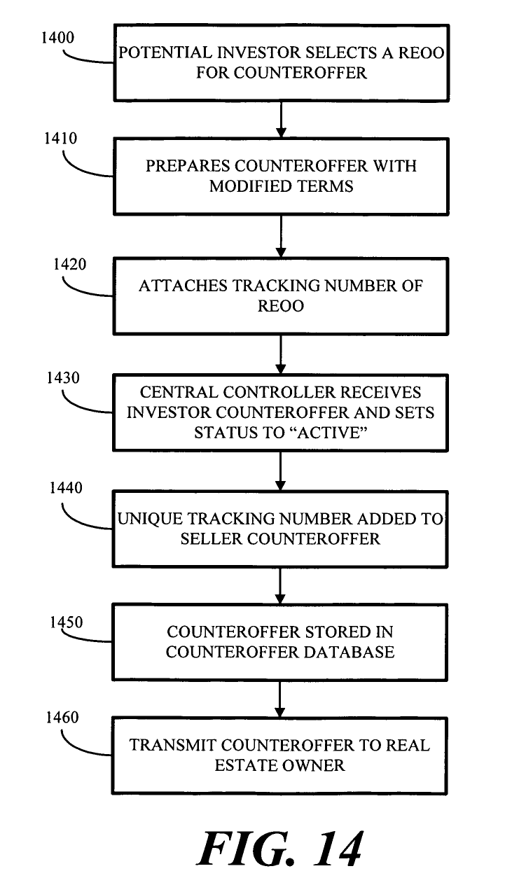

Turning now to FIG. 14, illustrated therein is a method for developing a counter offer in accordance with embodiments of the invention. At step 1400, the potential investor selects a REOO for which he wishes to make a counteroffer. At step 1410, the investor prepares the counteroffer with modified conditions. The investor follows the same process that the real estate owner uses to generate the REOO, as set forth in steps 500 through 580 of FIG. 5, selecting the terms and conditions as appropriate. Alternatively, the investor may be presented with an electronic copy of the initial REOO. The investor may then be allowed to edit those conditions that the investor wants to change. For example, the investor might take the real estate owner request for hundred thousand dollars and counteroffer with ninety thousand dollars.

At step 1420, the investor attaches the tracking number of the REOO to investor counteroffer. The central controller 200 receives the investor counteroffer at step 1430, setting the status to “active.” The central controller 200 then adds a unique tracking number to investor counteroffer at step 1440, and stores the counteroffer in the REOO database 265 at step 1450. The central controller 200 then extracts the tracking number of the REOO attached to investor counteroffer to determine to which real estate owner the investor counteroffer should be transmitted at step 1460.

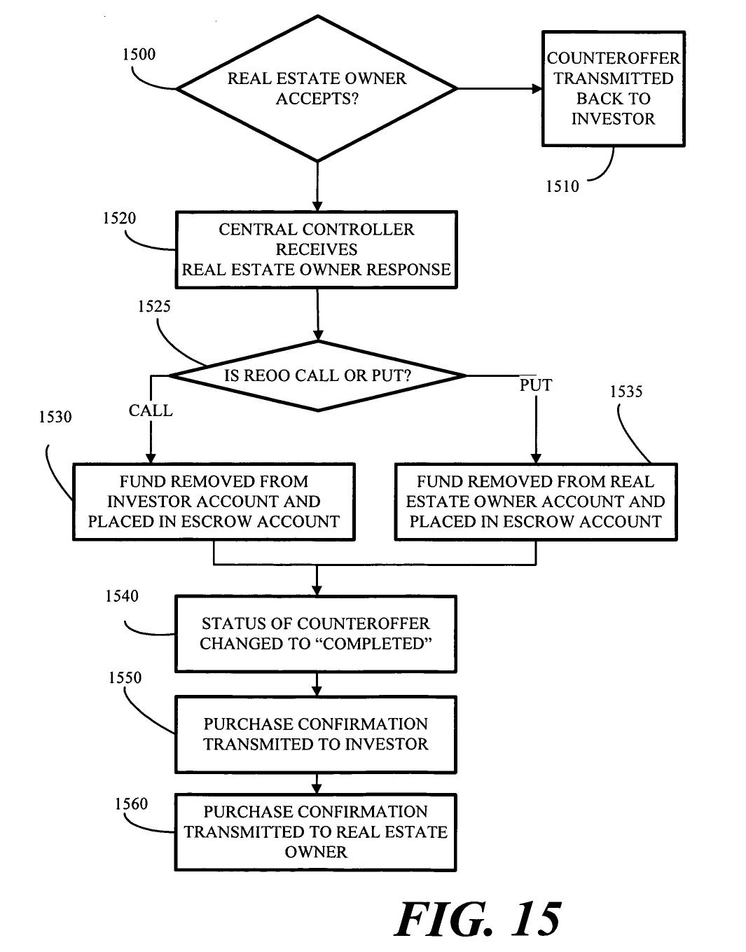

Turning now to FIG. 15, illustrated therein is one method by which the real estate owner responds to investor counteroffer in accordance with the invention. At step 1500, the real estate owner decides whether to accept the investor counteroffer. If he does not accept, the investor counteroffer is transmitted back to the investor at step 1510. If the real estate owner does decide to accept, a real estate owner acceptance 116 is transmitted to the central controller 200 at step 1520. At step 1525, if REOO is a call option, funds are removed from investor account database 276 and placed in escrow account database 299 at step 1530. Otherwise if REOO is a put option, at step 1535, funds are removed from real estate owner account database 275 and placed in escrow account database 299. At step 1540, the status of investor counteroffer is changed to “completed.” Transaction confirmation 130 is then transmitted to the investor at step 1550, and on to the real estate owner at step 1560. Procedures for the completion of REOO are described in FIG. 12.

As noted above, in some embodiments of the invention, real estate owners and investors communicate in an off-line manner with central controller 200. Rather than sending electronic mail or using web-based servers, real estate owners and investors use a telephone, fax machine, postal mail, or other off-line communication tool.

A real estate owner may use a telephone, for example, to generate the REOO. In one embodiment, the real estate owner calls the central controller 200 and is connected with an agent. The real estate owner provides the terms of the REOO, including the amount, expiration date, and other terms set forth above. The real estate owner also provides his unique user ID, password, or private key so that the central controller 200 can authenticate his identity via the membership system 209. The agent puts this data into digital form by typing it into a terminal and then adds legal language to form the REOO. The REOO is then transmitted to the central controller 200 where it is made available to potential investors as described in the on-line embodiment. In an alternative embodiment, the real estate owner calls the central controller 200 and is connected with a conventional Interactive Voice Response Unit (IVRU), which allows the real estate owner to enter some or all of the terms of the REOO without the assistance of a live agent.

Potential investors may also use a telephone to browse REOOs, or to make investor purchase commitments 120. The potential investor calls the central controller 200 and selects a real estate location. The central controller 200 then converts the text of each REOO into audio form, reading the entire list to the potential investor. At any time during the reading of the REOOs, the potential investor may press a combination of keys on his telephone to select a REOO for purchase commitment. The investor enters investor ID number and is authenticated by the central controller 200 using the membership system 209 prior to making a purchase commitment 120. Potential investors may also enter parameters before having the list of REOOs read to them. An investor, for example, might request that all REOOs for more than hundred thousand dollars be read, skipping any REOO with a lower amount. Real estate owners and investors may also communicate with an agent at the central controller 200 through faxes or postal mail. The agent receives the message and proceeds to digitize it and form REOO as described above.

In the previous embodiments, authentication of the real estate owner and investor involves checking the attached ID or name and comparing it with those stored in the investor database 260 and real estate owner database 255. Although this procedure works well in a low security environment, it can be significantly improved through the use of cryptographic protocols. These protocols not only enhance the ability to authenticate the sender of a message, but also serve to verify the integrity of the message itself. Such techniques shall be referred to generally as cryptographic assurance methods, and will include the use of both symmetric and asymmetric keys as well as digital signatures and hash algorithms.

The practice of using cryptographic protocols to ensure the authenticity of senders, as well as the integrity of messages, is well known in the art and need not be described here in detail. For reference, refer to Bruce Schneier, Applied Cryptography, Protocols, Algorithms, And Source Code In C, (2d Ed, John Wiley & Sons, Inc., 1996).

Where using cryptographic protocols, all messages between the central controller 200 and the real estate owner interface 300 or investor interface 400 may be authenticated and encrypted using well-known methods and software. For example, when the central controller 200 is configured as a web server, conventional communications software such as the Internet Explorer web browser from Microsoft Corporation may be used to secure exchange messages between the central controller 200 and the real estate owner interface 300 or investor interface 400.

As mentioned previously, embodiments of the present invention may provide anonymity for both real estate owners and investors. Such anonymity, in one embodiment, is accomplished by eliminating all references to the names of the individuals and businesses for all transactions. A real estate owner, for example, may include his unique ID number in the REOO rather than his name, thereby preventing the investor receiving the REOO from discovering the real estate owner's identity. This is desirable where the real estate owner, for example, does not want his neighbors about his desire to obtain money from his real estate parcel. In a similar manner, investors may also want to keep their identity a secret. An investor might not want the public to know that they are investing in certain real estate.

Although using unique ID numbers can provide anonymity, security is heightened when the unique ID numbers are encrypted with a private key of the central controller 200. In such an embodiment, anonymity is protected even where a database is stolen.

Alternate embodiments for anonymity include telephone messaging. When talking on the telephone, the identity of the real estate owner and investor could be hidden using conventional voice modification techniques. If the REOO or investor purchase commitment is in paper form, the form could be scanned using optical character recognition and translated into digital form, discarding any information that could be found in the original document.

Not all transactions require the transfer of money from the investor to the real estate owner or vice versa. In a barter transaction, the distinction between the real estate owner and the investor disappears, resulting in a contract for exchange between a first party and a second party. The first party posts the REOO and the second party posts a barter commitment to it. Instead of receiving cash, the first party receives real estate option from the second party. A first party who wanted to post a REOO for a real estate parcel in Boston, for example, could post that REOO offering to exchange the real estate option in Boston for a real estate option in San Diego.

Although the previous embodiments have described the delivery of real estate option from real estate owner to investor, and also the delivery of money from investor to real estate owner, there will inevitably be disputes arising from some transactions, requiring follow-up activity to resolve these disputes. The present invention can support dispute resolution in two ways.

First, language may be included—perhaps as boilerplate or form language—into every REOO. This language, in one embodiment, requires that both parties submit to binding arbitration of all disputes. Binding arbitration helps to avoid more costly and time-consuming legal battles. Additionally, liquidated damages may be set which specify damage amounts for particular infractions of the REOO.

Second, the central controller 200 can support the arbitration process by providing an arbiter for each dispute. Such arbitration might be required when real estate information in the REOO provided by the real estate owner to the investor does not act in accordance with the requirements of the REOO. An investor requiring owner-occupied parcel in a counteroffer, for example, might seek damages against an owner who leases property to tourists. Instead of seeking damages, the investor may seek a monetary reward, such as rebate or discount on the original REOO amount. In an arbitration involving real estate information, the investor may submit evidence to the central controller 200 along with the tracking number of the REOO 110, thereby allowing the arbiter to establish whether the real estate owner has fulfilled the conditions of the REOO.

In an alternative embodiment, transaction data can be sent to third party arbiters outside the system. The central controller 200 may send a copy of the REOO, investor purchase commitment, or purchase confirmation to the arbiters. Cryptographic keys may also be provided to the arbiters if there are questions of authenticity or non-repudiation.

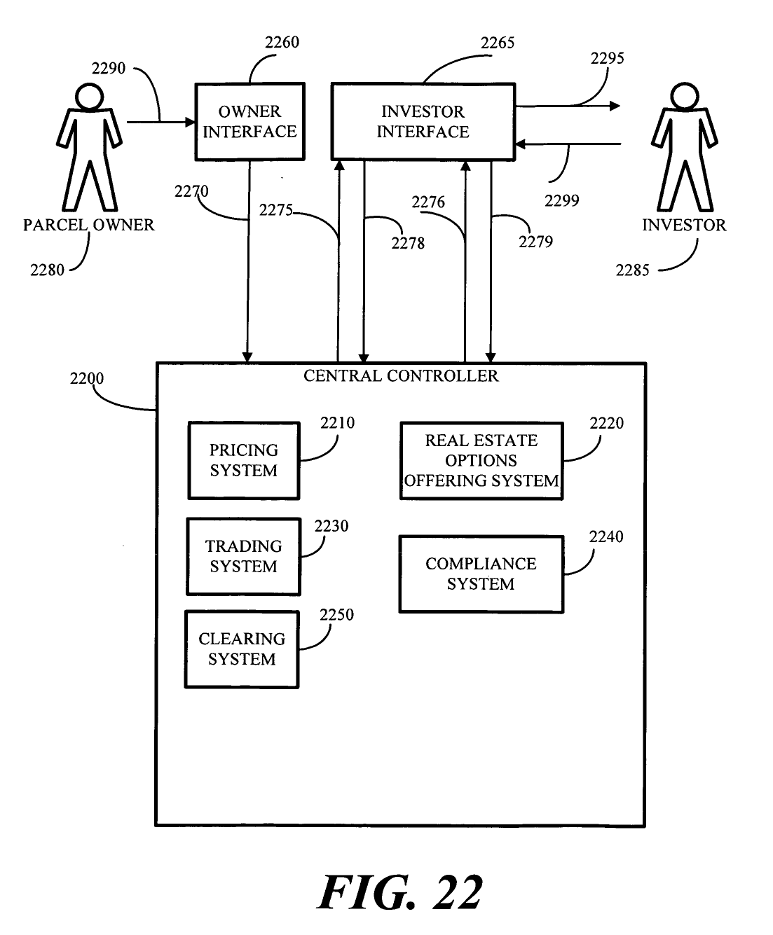

Turning now to FIG. 22, illustrated therein is one embodiment of a schematic block diagram illustrating a method of real estate options sale management system for creating, marketing, and selling real estate options in accordance with the invention. As noted above, but illustrated in general form in FIG. 22, in one embodiment, a central controller 2200 includes a pricing system 2210, a real estate offering system 2220, a trading system 2230, a compliance system 2240, and a clearing system 2250. The pricing system 2210 is configured to process requests received by the networked, electronic, exchange apparatus for real estate parcel based options offering prices. The pricing system 2210 is further configured to deliver one or more real estate parcel based options offerings in response to the requests.

A real estate option offering system 2220 is configured to process real estate owner's request to initiate real estate parcel based options offerings. A trading system 2230 is configured to process purchase and sale of the real estate parcel based options offerings. A clearing system 2250 is configured to process financial transactions associated with the purchase and sale of the real estate parcel based options offerings. A compliance system 2240 is configured to maintain a record of central controller transactions.

The real estate parcel owner 2280 provides real estate parcel data 2290 to owner interface 2260. The owner interface 2260 submits the parcel data 2270 to the central controller 2200. In response, the central controller 2200 generates a real estate parcel based call options offer 2275 or put options offer 2276 or both associated with the electronic real estate parcel data, and makes the real estate parcel based call options offer 2275 and put options offer 2276 available to the investor interface 2265. Investors 2285 utilize the investor interface 2265 to view the real estate parcel based call options offers 2275 and put options offers 2276. The investors 2285 also use the investor interface 2265 to generate purchase and sale commitments 2299, which are submitted to the investor interface 2265. The investor interface 2265 then communicates the purchase commitments 2278 and the sale commitments 2279 to central controller 2200 for processing.

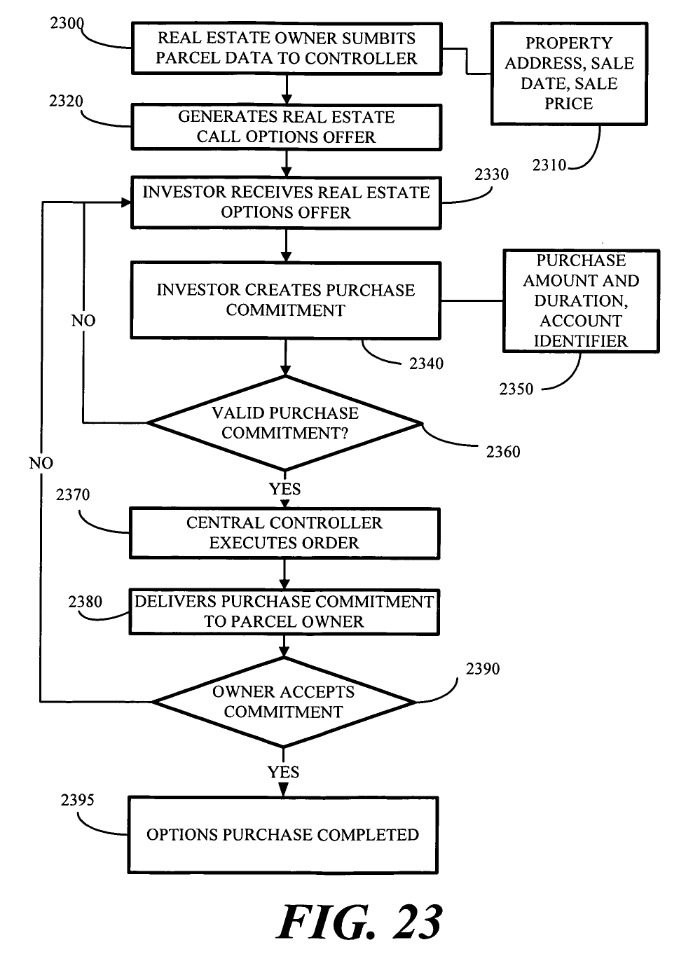

Now turning to FIG. 23, illustrated therein is a general embodiment of a method for creating, marketing, and selling real estate call options in accordance with embodiments of the invention. At step 2300, a system hub, such as the central controller 2200, receives electronic real estate parcel data from the owner interface 2260. In one embodiment, the electronic real estate parcel data includes at least an address and the last recorded sale price and sale date as shown at step 2310. At step 2320, the central controller 2200 generates and delivers the real estate parcel based call option offer 2275 to the investor interface 2265. The central controller 2200 optionally adds a tracking number and time stamp to the real estate parcel based call option offer 2275. At step 2330, the investor 2285 reviews the real estate parcel based call option offer 2275 and may choose to purchase it. If the investor 2285 elects to purchase the real estate parcel based call options offer 2275, at step 2340 the investor 2285 creates a purchase commitment 2278 and submits it to the investor interface 2265. The real estate parcel based call options offer 2275, in on embodiment, includes at least a minimum purchase amount, price, contract expiration, percentage share and an offering duration as show in step 2350.

The central controller 2200 validates the purchase commitment 2278 at step 2360. Validation may be performed to determine whether the purchase commitment 2278 exceeds the minimum purchase amount and price of the real estate parcel based call option offer 2275. Validation may also be performed to determine whether an offer duration has expired prior to receipt of the purchase commitment 2278. In addition, at step 2360 the central controller 2200 validates the minimum purchase amount, price and the offering duration against the purchase commitment 2278.

If the purchase commitment 2278 passes validation, the central controller 2200 executes it at step 2370 by retrieving an electronic financial account identifier associated with the purchase commitment 2278 from the investor interface 2265 and executing an electronic transfer of funds via the electronic financial account identifier. The central controller 2200 optionally adds a tracking number and time stamp to the purchase commitment as well. If the purchase commitment 2278 is not valid, notice of this invalidity is communicated back to investor 2285 at step 2360.

Once the central controller 2200 executes the order it is delivered to the parcel owner 2280 at step 2380 via the owner interface 2260. At step 2390, the parcel owner 2280 may choose to accept the purchase commitment 2278. Where accepted, the option purchase is completed at step 2395. The parcel owner 2280 can issue a counteroffer as well. The central controller 2200 delivers any counteroffer to the investor interface 2265 at step 2330.

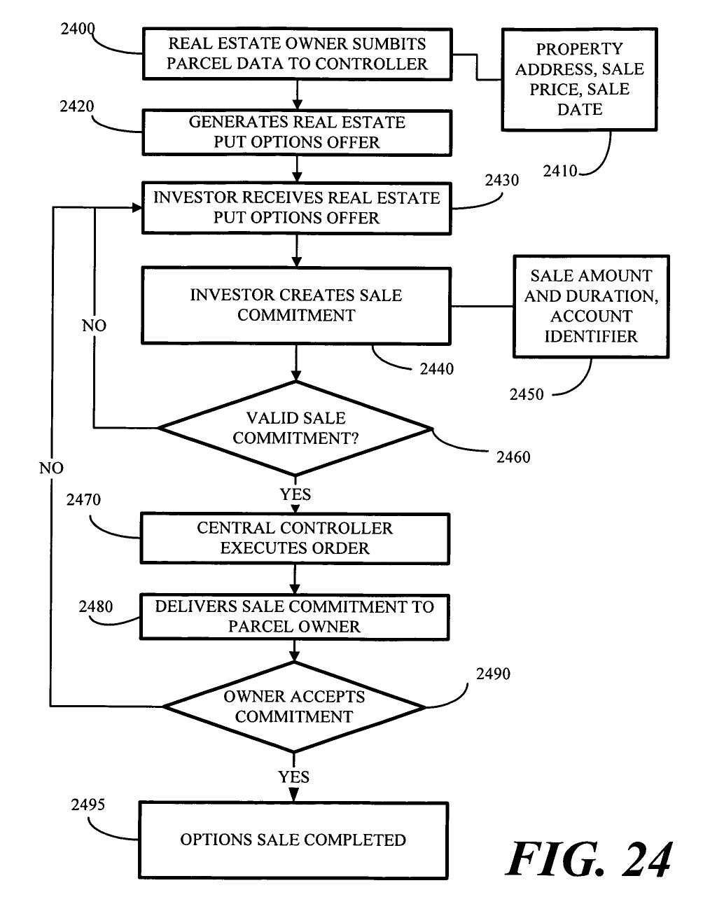

Now turning to FIG. 24, illustrated therein is a general embodiment of a method for creating, marketing, and buying real estate put options in accordance with embodiments of the invention. At step 2400, a system hub, such as the central controller 2200, receives electronic real estate parcel data from the owner interface 2260. In one embodiment, the electronic real estate parcel data includes at least an address and the last recorded sale price and sale date as shown at step 2410. At step 2420, the central controller 2200 generates and delivers the real estate parcel based put option offer 2276 to the investor interface 2265. The central controller 2200 optionally adds a tracking number and time stamp to the real estate parcel based put option offer 2276. At step 2430, the investor 2285 reviews the real estate parcel based put option offer 2276 and may choose to sell it. If the investor 2285 elects to sell the real estate parcel based put options offer 2276, at step 2440 the investor 2285 creates a sale commitment 2279 and submits it to the investor interface 2265. The real estate parcel based options put offer 2276, in on embodiment, includes at least a minimum purchase amount, price, contract expiration and an offering duration as show in step 2450.

The central controller 2200 validates the sale commitment 2279 at step 2460. Validation may be performed to determine whether the sale commitment 2279 exceeds the minimum purchase amount and price of the real estate parcel based put option offer 2276. Validation may also be performed to determine whether an offer duration has expired prior to receipt of the sale commitment 2279. In addition, at step 2460 the central controller 2200 validates the minimum purchase amount, price and the offering duration against the sale commitment 2279.

If the sale commitment 2279 passes validation, the central controller 2200 executes it at step 2470 by retrieving an electronic financial account identifier associated with the sale commitment 2279 from the investor interface 2265 and executing an electronic transfer of funds via the electronic financial account identifier. The central controller 2200 optionally adds a tracking number and time stamp to the sale commitment 2279 as well. If the sale commitment 2279 is not valid, notice of this invalidity is communicated back to investor 2285 at step 2460.

Once the central controller 2200 executes the order it is delivered to the parcel owner 2280 at step 2480 via the owner interface 2260. At step 2490, the parcel owner 2280 may choose to accept the sale commitment 2279. Where accepted, the option sale is completed at step 2495. The parcel owner 2280 can issue a counteroffer as well. The central controller 2200 delivers any counteroffer to the investor interface 2265 at step 2430.

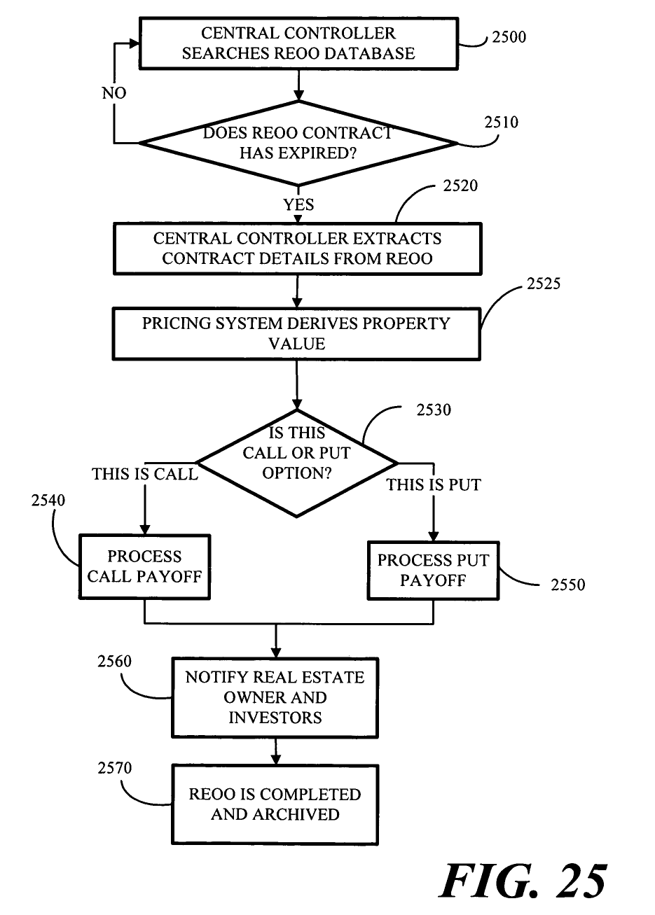

Turning now to FIG. 25, illustrated therein is one method for processing options payoff at the option expiration in accordance with embodiments of the invention. Such payoffs are associated with the particular REOO. At step 2500, the central controller 200 searches the REOO database 265 for REOOs with contract date which has expired. At step 2510, the central controller 200 confirms whether a selected REOO contract has expired. If the option contract is not expired, the central controller 200 returns to step 2500 and continues searching the REOO database 265. If the option contract is expired, at step 2520 the central controller 200 extracts all options contract details from REOO, including parcel address.

At step 2525, the pricing system 210 derives a property value at the current date. To establish the price of the real estate parcel the pricing system 210 uses a weighted combination of one or more local real estate price indexes and price provided by automated valuation system from the real estate information system 160. For instance, in one embodiment, a software method is executed in a computer to derive the property value at the current date. First, the software program operating in the computer determines a last recorded sale price and sale date for the real estate parcel. This determination can be performed by accessing publicly available tax or sales records. Next, this last sale price is adjusted. Adjustment occurs, in one embodiment, when the software program applies a weighted average of an estimated price received from an automated valuation system and a real estate price index adjustment to the last recorded sale price. The last sale price can be determined from one or more real estate price databases. At step 2530 the central controller 200 determines if REOO is a call option or a put option.

At step 2540 if REOO is a call option the investor payoff is determined, in one embodiment, in the following way: The value of the real estate parcel determined in step 2525 is compared to the option contract future value specified in REOO. The call option payoff is the difference between the present value and the value specified in RESO. For example, if the contract future value price is $1.1 million and the current value is $1.4 million, the payoff to the investor is $300,000. On the other hand, if the current value is $1.0 million, the payoff is $0. The payoff prorated based on percentage share of the payoff specified in REOO contract. If the payoff is positive in step 2540, the central controller processes the payoff payments by withdrawing money from the real estate owner account database 275 and depositing it into accounts of the appropriate investors on record with the REOO in the investor account database 276.

At step 2550 if REOO is a put option the homeowner payoff is determined, in one embodiment, in the following way: The value of the real estate parcel determined in step 2525 is compared to the option contract future value specified in REOO. The put option payoff is the difference between the value specified in RESO and the present value of the real estate parcel. For example, if the contract future value price is $0.8 million and the current value is $0.6 million, the payoff to the property owner is $200,000. On the other hand, if the current value is $0.9 million, the payoff is $0. The payoff prorated based on percentage share of the payoff specified in REOO contract. If the payoff is positive in step 2550, the central controller processes the payoff payments by withdrawing money from the appropriate investors on record with the REOO in the investor account database 276 and depositing it into account of the real estate owner account database 275.

At step 2560, the central controller 200 notifies real estate owner of REOO 110 and investors on record of payoff processed. At step 2570, REOO 110 status is set to be “archived” and REOO contract is completed.

Embodiments of the present invention offer many advantages over prior art real estate financing solutions. A few of these advantages will be described here.

First, embodiments of the present invention do not rely on any one single financial entity to provide funds to the real estate parcel owner. Instead, funds are provided by plurality of investors, each investor participating in the upside of any appreciation of the value of their options holdings in the real estate parcel. Second, embodiments of the present invention offer the real estate parcel price protection and provide funds to the real estate parcel owner in the event if prices decline beyond expected value.

Next, embodiments of the present invention in deal only with derived financial instruments and not real estate parcel property. Further, embodiments of the present invention do not offer trading of one financial instrument. To the contrary, a single real estate parcel is subject to plurality of options, which may be owned and traded by plurality of investors.

Forth, embodiments of the present invention do not perform any pricing function—pricing is dictated purely by market forces. For example, pricing of a REOO is done based on obtained data, including property address and last record of sale.

Next, embodiments of the present invention are not limited to institutional investors. Individual investors may participate just as do institutional investors.

Next, embodiments of the present invention do not employ lend-lease agreements. To the contrary, real estate options are created in a single real estate parcel. Investors own these real estate options, without complex financial instruments like lend-lease agreements. Additionally, embodiments of the present invention do not employ equity interests in real property. While some prior art systems have taught providing index based call or put options in exchange for payment, the present invention uses parcel specific real estate options. Mortgages are not used either. Additionally, there are no third-party funds or pools of money required for equity ownership.

While, some prior art solutions propose third-party strawmen who owns a home and permit the homeowner to “rent back” in exchange for financing, embodiments of the present invention leave the homeowner as primary and single owner of the property with the associated benefits attached, including tax deductions. Title does not change on the property. Instead, systems and methods of the invention record liens against a parcel that reflect the monetary and contractual obligations. At the same time the property title and ownership maintained by the property owner.

Further, as noted above, embodiments of the present invention deal with a method of creating a financial derivative on a single real estate parcel with real estate options and selling those options to investors. The investors are then free to sell to others on an exchange. The present invention develops a multilateral buyer-seller driven system to exchange options and works as a third party to administer options issue and payoff distribution. By way of example, in addition do administering financing, the central controller of the present system can serve as a trusted arbitrator available to resolve any disputes, enforce established contracts and covenants, facilitate exchange of interests in options, and thereby increase buyer and seller confidence in the system and real estate options financing.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic system for creating, marketing, and selling real estate options, represented by put or call options in individual real estate parcels, between an owner of an individual real estate parcel and at least one of a plurality of investors, comprising:
a central controller, having a network interface coupled to a network, the central controller comprising a trading system configured to process purchase and sale of real estate parcel based option offerings;
an investor interface, coupled to the network interface across the network, configured to receive investor input; and
a real estate owner interface, coupled to the network interface across the network, configured to receive real estate owner input.

2. The electronic system of claim 1, wherein the central controller further comprises:
a pricing system configured to process investor requests received by the electronic system for real estate parcel based option offering prices, and to deliver one or more real estate parcel based option offerings in response to the investor input, wherein the pricing system is further configured to process offering requests received by the electronic system for option offerings, and to deliver one or more option offering choices in response to the offering requests;
a clearing system configured to process financial transactions associated with the purchase and sale of the real estate parcel based option offerings;
a compliance system configured to maintain a record of central controller transactions; and
a real estate option offering system configured to process requests by real estate owners to initiate the real estate parcel based option offerings.

3. The electronic system of claim 1, further comprising a real estate information system communication coupling connected across the network between the central controller and a real estate information system, wherein the real estate information system communication coupling is configured to receive information validating real estate parcel value, existing debt, property condition, and historical prices corresponding to a local area from the real estate information system.

4. The electronic system of claim 1, further comprising a bank communication coupling connected across the network between the central controller and a bank, wherein the bank communication coupling is configured to receive information validating funds from the bank.

5. The electronic system of claim 1, further comprising a credit agency communication coupling connected across the network between the central controller and a credit agency, wherein the credit agency communication coupling is configured to receive information validating real estate owner personal information from the credit agency.

6. The electronic system of claim 1, wherein the central controller further comprises a membership system, a real estate owner database, and an investor database, wherein the membership system is configured to authenticate an identity of at least one real estate owner and at least one investor by matching identities of real estate owners stored in the real estate owner database with certain system users, and by matching identities of investors stored in the investor database with other certain system users.

7. The electronic system of claim 2, further comprising a real estate option offering database, accessible by the central controller, wherein the central controller, upon receiving real estate parcel information from the real estate owner interface, is configured to invoke the real estate option offering system to create a plurality of real estate options corresponding to the real estate parcel information, and to store them in a real estate option offering database.

8. The electronic system of claim 7, wherein the central controller, upon receiving a request from the investor interface, is configured to invoke the pricing system to retrieve one or more real estate options from the real estate option offering database, associate a price with the one or more real estate options, and to deliver the price to the investor interface.

9. The electronic system of claim 8, further comprising a plurality of databases, accessible by the central controller, the plurality of databases comprising at least a purchase commitment database for storing purchase commitments of the real estate parcel based option offerings, and a clearing database for storing transaction data relating to the real estate parcel based option offerings.

10. The electronic system of claim 9, wherein the central controller, upon receiving a purchase commitment from the investor interface, is configured to invoke the trading system to generate an identifier specifying at least a financial account, the identifier being associated with the purchase commitment, and to store the purchase commitment and the identifier in the purchase commitment database.

11. The electronic system of claim 10, wherein the central controller, upon the purchase commitment being stored in the purchase commitment database, is configured to invoke the clearing system to transfer funds from an investor account to a real estate option owner account.

12. The electronic system of claim 9, further comprising a plurality of databases, the plurality of databases comprising one of a contract detail database, a real estate option database, and a payment database an audit database, an escrow database, and an investor offers database.

13. A method for creating, marketing, and selling real estate options, represented by option contracts in individual real estate parcels, between an owner of an individual real estate parcel and at least one of a plurality of investors, the method comprising the steps of:
providing a networked, electronic, exchange apparatus having a central controller, the central controller comprising:
a pricing system configured process requests received by the networked, electronic, exchange apparatus for real estate parcel based option offering prices, and to deliver one or more real estate parcel based option offerings in response to the requests;
a real estate option offering system configured to process requests by real estate owners to initiate real estate parcel based option offerings;
a trading system configured to process purchase and sale of the real estate parcel based option offerings;
a clearing system configured to process financial transactions associated with the purchase and sale of the real estate parcel based option offerings;
a compliance system configured to maintain a record of central controller transactions;
an investor interface; and
an owner interface;
receiving electronic real estate parcel data from the owner interface, the electronic real estate parcel data comprising at least an address, last recorded sale date and last recorded sale price;
generating a real estate parcel based option offer associated with the electronic real estate parcel data; and
delivering the real estate parcel based option offer to the investor interface.

14. The method of claim 13, wherein the real estate parcel based option offer corresponds to a single real estate parcel, further comprising the step of selling one of a partial interest in the real estate parcel based option offer or an entire interest in the real estate parcel based option offer to the at least one of the plurality of investors.

15. The method of claim 14, wherein the step of selling the one of the partial interest in the real estate parcel based option offer or the entire interest in the real estate parcel based option offer comprises selling the partial interest in the real estate parcel based option offer to prevent the owner of the individual real estate parcel from manipulating a payout corresponding to the real estate parcel based option offer.

16. The method of claim 13, further comprising the steps of:
receiving at least one purchase commitment from the investor interface in response to the step of delivering the real estate parcel based option offer when the real estate parcel based option offer comprises a call option;
receiving at least one sale commitment from the investor interface in response to the step of delivering the real estate parcel based option offer when the real estate parcel based option offer comprises a put option;
receiving an electronic financial account identifier associated with the at least one purchase commitment or the at least one sale commitment from the investor interface; and
executing an electronic transfer of funds via the electronic financial account identifier.

17. The method of claim 16, wherein the real estate parcel based option offer comprises at least a minimum purchase price, a future expected real estate parcel value, and a contract expiration date.

18. The method of claim 16, further comprising the step of the receiving a guarantee for future payment upon expiration of the real estate parcel based option offer, wherein the guarantee comprises one of a property equity interest, cash, or a combination thereof.

19. The method of claim 16, further comprising the step of determining whether the purchase price exceeds a minimum purchase price.

20. The method of claim 16, further comprising the step of determining whether an option duration has expired prior to receipt of the at least one purchase commitment or the at least one sale commitment.

21. The method of claim 16, further comprising the steps of validating the electronic real estate parcel data and validating the at least one purchase commitment or the at least one sale commitment.

22. The method of claim 16, further comprising the steps of:
delivering the at least one purchase commitment to the owner interface upon receiving the at least one purchase commitment;
receiving additional purchase commitment transaction details from the owner interface;
generating, electronically, a first counteroffer and delivering the first counteroffer to the investor interface;
delivering the at least one sale commitment to the owner interface upon receiving the at least one sale commitment;
receiving additional sale commitment transaction details from the owner interface; and
generating, electronically, a second counteroffer and delivering the second counteroffer to the investor interface.

23. The method of claim 16, further comprising the steps of adding a tracking number and time stamp to one of the real estate parcel based option offering or the at least one purchase commitment or the at least one sale commitment.

24. A method in a computer for determining a value of a real estate parcel to be used in pricing a real estate parcel based option, the method comprising the steps of determining a last recorded sale price for the real estate parcel, and adjusting the last recorded sale price by applying a weighted average of an estimated price received from an automated valuation system and a price change amount, wherein the price change amount is determined from one or more real estate price indices.
